(19) United States
(12) Patent Application Publication
(10) Pub. No.: US 2017/0225395 A1
(43) Pub. Date: Aug. 10, 2017

(54) THREE-DIMENSIONAL PRINTED MECHANORESPONSIVE MATERIALS AND RELATED METHODS

(71) Applicant: University of Washington, Seattle, WA (US)

(72) Inventors: Andrew J. Boydston, Seattle, WA (US); Duane Storti, Seattle, WA (US); Mark A. Ganter, Edmonds, WA (US); Gregory I. Peterson, Tacoma, WA (US); Michael Larsen, Seattle, WA (US); Mete Yurtoglu, Seattle, WA (US)

(73) Assignee: University of Washington, Seattle, WA (US)

(21) Appl. No.: 15/501,721

(22) PCT Filed: Aug. 5, 2015
(86) PCT No.: PCT/US15/43777

§ 371 Date: Feb. 3, 2017

Related U.S. Application Data
(60) Provisional application No. 62/033,590, filed on Aug. 5, 2014.
(60) Provisional application No. 62/049,275, filed on Sep. 11, 2014.

(51) Int. Cl. B29C 67/00; B33Y 80/00; B33Y 70/00; B33Y 10/00

(52) U.S. Cl. CPC B29C 67/0077; B29C 67/0055; B33Y 10/00; B33Y 80/00; B33Y 70/00; B29K 2995/002

(57) ABSTRACT

The present disclosure provides additive manufacturing methods that include depositing onto a substrate a material including a blend of a mechanochromic molecule and a matrix polymer; and fusing the material to provide an article. The mechanochromic molecule has a first end and a second end and includes at least one polymer chain covalently bound to each end.

### CROSS-REFERENCES TO RELATED APPLICATIONS

This application claims the benefit of U.S. Patent Application No. 62/033,590, filed Aug. 5, 2014, and U.S. Patent Application No. 62/049,275, filed Sep. 11, 2014, the disclosure of each of which is hereby incorporated by reference in its entirety.

### BACKGROUND

Additive manufacturing (also known as 3D printing, solid free-form fabrication, rapid prototyping and rapid manufacturing) includes several processes that produce three dimensional (3D) objects from a computer model by building up the object in a layer-by-layer manner. Examples of additive manufacturing processes include extrusion-based techniques (e.g., fused filament fabrication (FFF)), jetting, selective laser sintering/melting, laser engineered net shaping (LENS), powder-bed based 3D printing (e.g., powder/binder jetting), selective light modulation, electron-beam melting, and stereolithographic processes. These processes can fabricate objects from a variety of materials including metals, photopolymers, thermopolymers, and ceramics. For each of these processes, the digital representation of the 3D object is initially sliced into multiple layers. For each sliced layer, a computer provides the path instructions for the particular additive manufacturing system to print the given layer. The layers are then successively built up to form the final object.

In contrast to traditional manufacturing techniques such as injection or compression molding, the advantages of additive manufacturing include increased customizability, ease of use, orthogonality to existing manufacturing techniques, and accessibility to the additive manufacturing processes by a wide user base. Additive manufacturing has also become more available to the general public. For example, an extrusion-based technique, fused filament fabrication (FFF), has become accessible in private homes for printing the likes of toys, housewares, art pieces, and accessories for portable electronics.

In an extrusion-based additive manufacturing system, such as a fused filament fabrication (FFF) system, a 3D object can be printed from a digital representation of the object in a layer-by-layer manner by extruding a flowable material, such as a filament, through an extrusion tip carried by a print head of the system onto a substrate in an x-y plane. The extruded material fuses to previously deposited material and solidifies upon a drop in temperature. The position of the print head relative to the substrate is then incremented along a z-axis (perpendicular to the x-y plane), and the process is repeated to form a 3D object resembling the digital representation.

As another example, powder-based additive manufacturing processes deposit and modify powders. One example of a powder-based additive manufacturing process is the selective laser sintering process, where an object is constructed one layer at a time inside a thermally controlled process chamber, which is held at a temperature slightly below the melting point of the polymer system being used. A polymer powder is deposited in thin layers uniformly across a piston. A laser beam is scanned across the surface of a layer of powder, turning on and off to selectively sinter or fuse the polymer powder into a shape defined by a computer. After a given layer has been fused, the piston is lowered and a new layer of powder is added on top of the just completed layer. The new layer is then fused, based on the defined shape, and in this manner a 3D object can be fabricated from multiple layers.

As yet another example, selective light modulation (SLM) involves a photosensitive polymer precursor (often known as a ‘resin’) and a mechanism for exposing the photosensitive polymer precursor to electromagnetic radiation. The exposed photosensitive polymer precursor then undergoes a chemical reaction leading to polymerization and solidification (i.e., curing). In general, SLM methods include a vat to hold the photosensitive polymer precursor; a source of electromagnetic radiation (e.g., UV, near-UV, or visible light); a build platform; an elevator mechanism capable of adjusting the separation of the vat and the build platform; and a controlling computer. The source of electromagnetic radiation can be located above the vat, or below the vat. The source of the electromagnetic radiation can be a digital light processing (DLP), a digital micromirror device (DMD), a liquid crystal display (LCD), or a liquid crystal on silicon (LCOS).

As yet another example, in a jetting additive manufacturing process, a material is deposited from a nozzle which moves horizontally across the build platform. The material layers can then be cured or hardened using electromagnetic radiation and the object is built in a layer by layer manner.

Functional and responsive polymeric materials (i.e., smart materials) can be advantageously used in additive manufacturing processes. The smart materials can include piezoelectric materials, shape memory materials, magneto-strictive materials, pH-sensitive polymers, thermo-responsive polymers, chromogenic materials (liquid crystals and electrochromics), and thermoelectric materials. Of particular relevance to the length scales of 3D printed objects are smart polymers that enable translation of macroscopic inputs into molecular-level chemical outputs, such as those that are mechanically activated and chemically responsive. Importantly, this class of smart polymers has been realized through the development of “mechanophores,” molecules that are capable of mechanical-into-chemical energy transduction. The specific chemical outputs that have been demonstrated by various mechanophores provide a rich pool of capabilities including chemiluminescence, release of small molecules, generation of reactive sites for crosslinking within self-reinforcing materials, activation of metal catalysts, and mechanochromic indicators. However, despite the tremendous interest in development of mechanoresponsive “smart” materials, mechanophores have not been used in additive manufacturing.

Thus, an exciting and potentially transformative area of growth is the integration of “smart” functional polymeric materials with 3DP technologies. As these areas merge, the capabilities afforded by designer polymer synthesis can be incorporated into rapidly customizable objects and devices. The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, this disclosure features an additive manufacturing method that includes depositing onto a substrate a material including a blend of a mechanochromic molecule and a matrix polymer; and fusing the material to provide an article. The mechanochromic molecule has a first end and a second end and includes at least one polymer chain covalently bound to each end.

In another aspect, this disclosure features an additive manufacturing method that includes exposing a mixture that includes a mechanochromic initiator having at least two initiation groups, a first monomer capable of being covalently bound to each of the initiation groups of the mechanochromic initiator, and a second monomer capable of forming a matrix polymer to a stimulus; and polymerizing the monomers to provide a polymerized article.

In yet another aspect, this disclosure features an article, including a blend of a mechanochromic molecule and a first matrix polymer. The mechanochromic molecule has a strained moiety capable of rearranging to a colored moiety; the mechanochromic molecule further has a first end and a second end and includes at least one polymer chain covalently bound to each end.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings.

FIG. 1 is a schematic representation of a mechanochromic polymer used in a fused filament fabrication process and a printing or jetting process for the formation of a mechanochromic article.

FIG. 2 is a schematic depiction of a mechanochemical isomerization of a spiropyran moiety to its merocyanine form.

FIG. 3 is schematic depiction of the chemical structures of embodiments of spiropyran initiators and resulting polymers.

FIGS. 4A-4D are photographs of tensile test specimens made from embodiments of polymers ((4A) 2₁₀₀, (4B) 2₅₀, (4C) 2₁₀, and (4D) 4₅₀) pre- (left) and post-elongation (right). The vertical lines indicate the positions of the load frame clamps.

FIG. 5A is computer-aided design (CAD) representation of an embodiment of a dual-material tensile test specimen, the dark stripes indicating the location of an embodiment of a mechano-active filament.

FIG. 5B is a photograph of the test specimen of FIG. 5A pre-elongation.

FIG. 5C is a photograph of the test specimen of FIG. 5B post-elongation.

FIG. 5D is a photograph of the test specimen of FIG. 5C after UV irradiation.

FIG. 6A is a CAD representation of an embodiment of a tensile test specimen in which a mechano-active region is encased by a non-mechanoresponsive filament.

FIG. 6B is a photograph of an embodiment of a test specimen in which a mechano-active polymer (2₅₀) is encased by a non-mechanoresponsive filament (C₁₀₀).

FIGS. 6C and 6D are photographs of the test specimen of FIG. 6B post-elongation showing the activation of the mechano-active polymer (2₅₀).

FIG. 6E is a photograph of the elongated and cut test specimen of FIGS. 6C and 5D showing the encased filament of the mechano-active polymer (2₅₀).

FIG. 7A is a photograph of an embodiment of a tensile test specimen in which a mechano-active polymer (2₅₀) is encased by a non-mechano-active polymer (4₅₀).

FIG. 7B is a photograph of the test specimen of FIG. 7A post-elongation showing the activation of the mechano-active polymer (2₅₀).

FIG. 7C is a photograph of the elongated and cut test specimen of FIG. 7B showing the encased filament of the mechano-active polymer (2₅₀).

FIG. 8A is photograph of an embodiment of a tensile test specimen with embedded rectangular regions of a mechano-active polymer (2₅₀) at different angles.

FIG. 8B is photograph of the test specimen of FIG. 8A post-elongation showing activation of the mechano-active polymer regions.

FIG. 8C is a photograph of an embodiment of a tensile test specimen with an embedded mechano-active polymer (2₅₀) spelling “3DP”.

FIG. 8D is a photograph of the test specimen of FIG. 8C post-elongation showing activation of the mechano-active polymer regions.

FIG. 9 is schematic illustration of an embodiment of a spiropyran mechanophore incorporated into a polycaprolactone (PCL) polymer and application of elongational force to effect conversion to the merocyanine dye.

FIG. 10 is an illustration showing the CAD design of an embodiment of a tensile test specimen with embedded “UW” letters.

FIG. 11 is an illustration showing CAD designs of an embodiment of a fracture test specimen, with the regions including an embodiment of a matrix polymer (e.g., commercial polycaprolactone) indicated with a “1” and the region including a mechanoresponsive polymer blend indicated with a “2”.

FIG. 12 is an illustration showing CAD design of an embodiment of an asymmetric tensile test specimen with embedded regions of mechanoresponsive material.

FIG. 13 shows photos of elongated samples of an embodiment of a mechanoresponsive material at various blend concentrations. The top row of photos show a mechanochromic color change and the bottom row show a photochemical color change of the sample post-elongation. The spiropyran concentration for each blend is as follows (blend % w/w, spiropyran % w/w): 1, 0.005; 3, 0.015; 5, 0.025; 10, 0.05; 20, 0.10; 50, 0.25.

FIG. 14A is a photograph an embodiment of a tensile test specimen with an embedded mechano-responsive material in the shape of “UW.”

FIG. 14B is a photograph of the test specimen of FIG. 14A during elongation with an Instron machine.

FIG. 14C is a photograph of the test specimen of FIG. 14A post elongation.

FIG. 14D is a photograph of the test specimen of FIG. 14A post elongation under direct UV irradiation (365 nm).

FIG. 15A is a photograph of an embodiment of a fracture test specimen before testing.

FIGS. 15B and 15C are photographs of the fracture test specimen of FIG. 15A during testing, with changing color at the crack tip.

FIG. 15D is a photograph of the fracture test specimen of FIG. 15A after testing, showing plastic deformation and color change around the crack tip.

FIG. 16 is graph of load versus tensile extension for an embodiment of a force sensor with the numbers along the graph corresponding to the numbered pictures. The black line is from a representative experiment, and the dots indicate the onset of activation of a mechano-responsive polymer/matrix region (determined visually) with error bars=1 standard deviation from an average of three runs.

FIG. 17 is a photograph of an embodiment of a force sensor post-elongation. The white arrow indicates the necking direction.

### DETAILED DESCRIPTION

In general, materials that are specially designed to be stimuli-responsive are referred to as “smart” materials. As used herein, “mechanically activated” is used herein to indicate a mechanical stimulus and “chemically responsive” is used herein to indicate a chemical response or output (to any variety of stimulus). Thus, mechanically activated, chemically responsive smart materials, are realized through the incorporation of molecules that undergo chemical reactions in response to mechanical forces, and are referred to as “mechanophores.” A type of mechanophore is a mechanochromic molecule, which is a compound that changes color upon exposure to mechanical force.

The present disclosure provides an additive manufacturing method, including depositing onto a substrate a material including a blend of a mechanochromic molecule and a matrix polymer; and fusing the material to provide an article. The mechanochromic molecule has a first end and a second end and includes at least one polymer chain covalently bound to each end.

The material including a blend of a mechanochromic molecule and a matrix polymer can change color when the material is subjected to mechanical stress (e.g., pulling, compressing, bending). The color change can be reversible, such that when the material that has undergone a color change it can revert to its initial non-colored state over time, when the mechanical stress has been removed. The material can find numerous applications, such as in pressure sensors and tensile stress sensors.

### Definitions

At various places in the present specification, substituents of compounds of the disclosure are disclosed in groups or in ranges. It is specifically intended that the disclosure include each and every individual subcombination of the members of such groups and ranges. For example, the term “C₁₋₆ alkyl” is specifically intended to individually disclose methyl, ethyl, C₃ alkyl, C₄ alkyl, C₅ alkyl, and C₆ alkyl.

It is further appreciated that certain features of the disclosure, which are, for clarity, described in the context of separate embodiments, can also be provided in combination in a single embodiment.

Conversely, various features of the disclosure which are, for brevity, described in the context of a single embodiment, can also be provided separately or in any suitable sub combination.

As used herein, the term “substituted” or “substitution” refers to the replacing of a hydrogen atom (H) with a substituent other than H. For example, an “N-substituted piperidin-4-yl” refers to replacement of the H atom from the NH of the piperidinyl with a non-hydrogen substituent such as, for example, alkyl.

As used herein, “depositing/deposition” refers to setting down of a material onto a substrate or a material supported by a substrate.

As used herein, “blend” refers to a mixture of two or more components.

As used herein, “mechanochromic molecule” refers to a molecule that changes color upon exposure to mechanical force. In some embodiments, the color change is reversible, such that a color appears over a period of time upon application of a mechanical force and disappears over a period of time upon removal of the mechanical force. In some embodiments, upon application of a mechanical force, the molecule can change from colored to colorless. As used herein, the mechanochromic molecule is the entire molecule, which can include any covalently bound polymers. The mechanochromic moiety is a portion of the mechanochromic molecule that provides the color changing property, such as a spiropyran core, a naphthopyran core, or a spirooxazine core.

As used herein, “matrix polymer” refers to a polymer that surrounds the mechanochromic molecules (i.e., the matrix polymer provides a matrix for the mechanochromic molecules).

As used herein, “strained moiety” refers to a portion of a molecule having a stress that raises its internal energy. The stress can take the form of torsional strain, ring strain, and/or steric strain.

As used herein, “conjugated” refers to the overlay of one p-orbital with another across an intervening sigma bond. In transition metals, d-orbitals can be involved. A conjugated system has a region of overlapping p-orbitals, bridging the intervening single bonds. Delocalization of pi electrons across all the adjacent aligned p-orbitals can occur, where the pi electrons do not belong to a single bond or atom, but to a group of atoms.

As used herein, “colored” refers to a molecule that absorbs in the visible wavelength range of about 380 to 780 nm.

As used herein, “selective laser sintering” refers to an additive manufacturing technique that uses a laser as the power source to sinter (i.e., heat and fuse) powdered material (e.g., a polymer, or a polymer blend).

As used herein, “fused filament fabrication” (FFF) refers to an additive manufacturing technique that lays down material in layers. In fused filament fabrication, a plastic filament is unwound from a coil and supplies material to produce a part. FFF is also known as ASTM F2792-12A Material Extrusion.

As used herein, “jetting” refers to an additive manufacturing technique that is similar to inkjet document printing, but instead of jetting drops of ink onto paper, drops of polymer are jetted onto a tray, and a stimulus (e.g., light and/or heat) is used to cure the layers.

As used herein, “initiation group” refers to a functional group that reacts with a monomer to form an intermediate compound capable of linking successively with a number of other monomers into a polymeric compound.

As used herein, “mechanochromic initiator” refers to a mechanochromic chemical species that reacts with a monomer to form an intermediate compound capable of linking successively with a number of other monomers into a polymeric compound.

As used herein, “rearrangement/rearranging” refers to a chemical reaction where the carbon skeleton of a molecule is rearranged to give a structural isomer of the original molecule.

As used herein, “intimately mixed” refers to a homogeneous mixture of two or more components.

As used herein, “macrophase separation” refers to a macroscopic phase separation, usually between immiscible polymers. Macrophase separation results in homogeneous regions spanning 0.1 to 1 mm.

As used herein, “microphase separation” refers to mixtures of two or more polymers that separate to form periodic nanostructures. The nanostructures can take the form of lamellae (i.e., layers), hexagonally packed cylinders, gyroid phases, etc. The nanostructures can range in size from 1 to 100 nm.

As used herein, “integrally embedded” refers to a first material that is directly formed together with one or more materials. The first material can be partially integrated or fully integrated within the one or more materials. In some embodiments, the one or more materials may be optically translucent, so as to permit viewing of any color changes that occur, while still encompassing and protecting a mechanochromic first material.

As used herein, “vat polymerization” refers to an additive manufacturing technique where 3-dimensional objects are formed by photopolymerization. Specifically, a projector projects an image with light onto a vat of monomers of polymer precursors in solution, which when exposed to light, polymerizes the monomers or polymer precursors into a solid polymer. The solid polymer is deposited in a layer by layer fashion to form a 3-dimensional object.

As used herein, “ink jet printing” refers to an additive manufacturing technique where curable liquid monomer or polymer precursors is deposited in a layer-by-layer manner and cured onto a build tray.

As used herein, the term “alkyl” refers to a saturated hydrocarbon group which is straight-chained (e.g., linear) or branched. Example alkyl groups include methyl (Me), ethyl (Et), propyl (e.g., n-propyl and isopropyl), butyl (e.g., n-butyl, isobutyl, t-butyl), pentyl (e.g., n-pentyl, isopentyl, neopentyl), and the like. An alkyl group can contain from 1 to about 30, from 1 to about 24, from 2 to about 24, from 1 to about 20, from 2 to about 20, from 1 to about 10, from 1 to about 8, from 1 to about 6, from 1 to about 4, or from 1 to about 3 carbon atoms.

As used herein, the term “alkylene” refers to a linking alkyl group.

As used herein, the term “aryl” refers to monocyclic or polycyclic (e.g., having 2, 3, or 4 fused rings) aromatic hydrocarbons such as, for example, phenyl, naphthyl, anthracenyl, phenanthrenyl, indanyl, and indenyl. In some embodiments, aryl groups have from 6 to about 20 carbon atoms.

As used herein, the term “arylene” refers to a linking aryl group.

As used herein, the term “halo” or “halogen” includes fluoro, chloro, bromo, and iodo.

As used herein, “alkenyl” refers to an alkyl group having one or more double carbon-carbon bonds. The alkenyl group can be linear or branched. Example alkenyl groups include ethenyl, propenyl, and the like. An alkenyl group can contain from 2 to about 30, from 2 to about 24, from 2 to about 20, from 2 to about 10, from 2 to about 8, from 2 to about 6, or from 2 to about 4 carbon atoms.

As used herein, “alkenylene” refers to a linking alkenyl group.

As used herein, “alkynyl” refers to an alkyl group having one or more triple carbon-carbon bonds. The alkynyl group can be linear or branched. Example alkynyl groups include ethynyl, propynyl, and the like. An alkynyl group can contain from 2 to about 30, from 2 to about 24, from 2 to about 20, from 2 to about 10, from 2 to about 8, from 2 to about 6, or from 2 to about 4 carbon atoms.

As used herein, “alkynylene” refers to a linking alkynyl group.

As used herein, “alkoxy” refers to an —O-alkyl group. Example alkoxy groups include methoxy, ethoxy, propoxy (e.g., n-propoxy and isopropoxy), t-butoxy, and the like.

As used herein, “haloalkyl” refers to an alkyl group having one or more halogen substituents. Example haloalkyl groups include CF₃, C₂F₅, CHF₂, CCl₃, CHCl₂, C₂Cl₅, and the like.

As used herein, “haloalkoxy” refers to an —O-(haloalkyl) group.

As used herein, “aryl” refers to monocyclic or polycyclic (e.g., having 2, 3 or 4 fused rings) aromatic hydrocarbons such as, for example, phenyl, naphthyl, anthracenyl, phenanthrenyl, indanyl, indenyl, and the like. In some embodiments, aryl groups have from 6 to about 20 carbon atoms.

As used herein, “arylene” refers to a linking aryl group.

As used herein, “heteroalkyl” refers to an alkyl group having at least one heteroatom such as sulfur, oxygen, or nitrogen.

As used herein, “heteroalkylene” refers to a linking heteroalkyl group.

As used herein, a “heteroaryl” refers to an aromatic heterocycle having at least one heteroatom ring member such as sulfur, oxygen, or nitrogen. Heteroaryl groups include monocyclic and polycyclic (e.g., having 2, 3 or 4 fused rings) systems. Any ring-forming N atom in a heteroaryl group can also be oxidized to form an N-oxo moiety. Examples of heteroaryl groups include without limitation, pyridyl, N-oxopyridyl, pyrimidinyl, pyrazinyl, pyridazinyl, triazinyl, furyl, quinolyl, isoquinolyl, thienyl, imidazolyl, thiazolyl, indolyl, pyrryl, oxazolyl, benzofuryl, benzothienyl, benzthiazolyl, isoxazolyl, pyrazolyl, triazolyl, tetrazolyl, indazolyl, 1,2,4-thiadiazolyl, isothiazolyl, benzothienyl, purinyl, carbazolyl, benzimidazolyl, indolinyl, and the like. In some embodiments, the heteroaryl group has from 1 to about 20 carbon atoms, and in further embodiments from about 3 to about 20 carbon atoms. In some embodiments, the heteroaryl group contains 3 to about 14, 3 to about 7, or 5 to 6 ring-forming atoms. In some embodiments, the heteroaryl group has 1 to about 4, 1 to about 3, or 1 to 2 heteroatoms.

As used herein, “heteroarylene” refers to a linking heteroaryl group.

As used herein, the term “random copolymer” is a copolymer having an uncontrolled mixture of two or more constitutional units. The distribution of the constitutional units throughout a polymer backbone can be a statistical distribution, or approach a statistical distribution, of the constitutional units. In some embodiments, the distribution of one or more of the constitutional units is favored. For a polymer made via a controlled polymerization (e.g., RAFT, ATRP, ionic polymerization), a gradient can occur in the polymer chain, where the beginning of the polymer chain (in the direction of growth) can be relatively rich in a constitutional unit formed from a more reactive monomer while the later part of the polymer can be relatively rich in a constitutional unit formed from a less reactive monomer, as the more reactive monomer is depleted. To decrease differences in distribution of the constitutional units, comonomers in the same family (e.g., methacrylate-methacrylate, acrylamide-acrylamido) can be used in the polymerization process, such that the monomer reactivity ratios are similar.

As used herein, the term “constitutional unit” of a polymer refers to an atom or group of atoms in a polymer, comprising a part of the chain together with its pendant atoms or groups of atoms, if any. The constitutional unit can refer to a repeat unit. The constitutional unit can also refer to an end group on a polymer chain. For example, the constitutional unit of polyethylene glycol can be —CH₂CH₂O— corresponding to a repeat unit, or —CH₂CH₂OH corresponding to an end group.

As used herein, the term “repeat unit” corresponds to the smallest constitutional unit, the repetition of which constitutes a regular macromolecule (or oligomer molecule or block).

As used herein, the term “end group” refers to a constitutional unit with only one attachment to a polymer chain, located at the end of a polymer. For example, the end group can be derived from a monomer unit at the end of the polymer, once the monomer unit has been polymerized. As another example, the end group can be a part of a chain transfer agent or initiating agent that was used to synthesize the polymer.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### Mechanochromic Molecule

The mechanochromic molecule or mechanophore of the present disclosure is a molecule that can provide a chemical response (e.g., a color change) upon exposure to a mechanical stimulus. The mechanochromic molecule includes a strained moiety, such as a spirocyclic moiety, that can rearrange to a colored moiety upon exposure to a mechanical stimulus. In some embodiments, the rearrangement of the strained moiety to a colored moiety can relieve a strain in the mechanochromic molecule. In some embodiments, the colored moiety is a conjugated planar moiety.

The mechanochromic moiety has a first end and a second end and includes at least one polymer chain covalently bound to each end. The first end is on one side of the strained moiety, and the second end is on the opposite side of the strained moiety (i.e., the mechanochromatic moiety is intermediate the polymer chains covalently coupled to each end of the moiety). The mechanochromic moiety is covalently bound to two or more polymers, where at least one polymer is located at each end of the mechanochromic moiety. The two or more polymers can be the same or different. The two or more polymers can have the same or different molecular weights. Examples of polymers include polycarbonates, polyamides, polyethers, polyurethanes, polyolefins, polyacrylates, and/or polyacrylamides. For example, the polymer can be a poly(ε-caprolactone), an polylactic acid (PLA), an acrylonitrile butadiene styrene (ABS), a polyvinyl alcohol, a nylon, and/or a polyethylene glycol.

The mechanochromic moiety can be conjugated to the polymer in any of a variety of ways known to a person of ordinary skill in the art. For example, the mechanochromic moiety can be conjugated to the polymer via a linkage such as —OC(O)—, —C(O)O—, —NHC(O)—, —O—, —NH—, —NR—, —S—, S(O), —SO₂—, —OSiO—, —OP(O)(OH)—, and/or —OP(O)(NR₂)—.

The mechanochromic molecule can have a weight average molecular weight (M_{w}) of from about 30 to about 200 kDa.

In some embodiments, the mechanochromic moiety includes a spiropyran moiety, a naphthopyran moiety (e.g., an indenonaphthopyran moiety), or a spirooxazine moiety. Examples of the rearrangement of these moieties (e.g., spiro to conjugated forms) are shown below.

Spiropyran Moiety

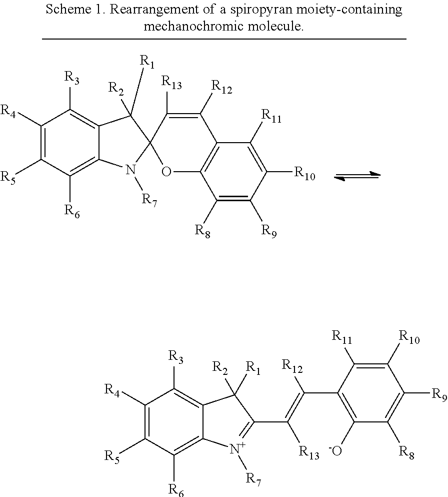

wherein in Scheme 1:
R₁ and R₂ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, and C₁₋₆ haloalkoxy;
R₃, R₄, R₅, R₆, and R₇ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer;
R₈, R₉, R₁₀, and R₁₁ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₈, R₉, R₁₀, or R₁₁ is a polymer, or two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer; and
R₁₂ and R₁₃ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, and C₁₋₆ haloalkoxy.

In some embodiments, R₁ and R₂ are each independently selected from H, C₁₋₆ alkyl, C₁₋₆ alkoxy, aryl, heteroaryl, halo, C₁₋₆ haloalkyl, and C₁₋₆ haloalkoxy.

In some embodiments, R₁ and R₂ are each independently selected from H, C₁₋₆ alkyl, C₁₋₆ alkoxy, halo, C₁₋₆ haloalkyl, and C₁₋₆ haloalkoxy.

In some embodiments, R₁ and R₂ are each independently selected from H and C₁₋₆ alkyl.

In some embodiments, R₁ and R₂ are each independently selected from C₁₋₆ alkyl.

In some embodiments, R₁ and R₂ are each H.

In some embodiments, R₃, R₄, R₅, R₆, and R₇ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H, C₁₋₆ alkyl, C₁₋₆ alkoxy, halo, C₁₋₆ haloalkyl, C₁₋₆ haloalkoxy, and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H, C₁₋₆ alkyl, and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, or R₇ is a polymer.

In some embodiments, R₃, R₄, R₅, R₆, and R₇ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, or R₇ is a polymer.

In some embodiments, R₃, R₄, R₅, R₆, and R₇ are each independently selected from H, C₁₋₆ alkyl, C₁₋₆ alkoxy, halo, C₁₋₆ haloalkyl, C₁₋₆ haloalkoxy, and a polymer, provided that at least one of R₃, R₄, R₅, R₆, or R₇ is a polymer.

In some embodiments, R₃, R₄, R₅, R₆, and R₇ are each independently selected from H, C₁₋₆ alkyl, and a polymer, provided that at least one of R₃, R₄, R₅, R₆, or R₇ is a polymer.

In some embodiments, R₃, R₄, R₅, R₆, and R₇ are each independently selected from H and a polymer, provided that at least one of R₃, R₄, R₅, R₆, or R₇ is a polymer.

In any of the embodiments above pertaining to R₃, R₄, R₅, R₆, or R₇: in certain embodiments, one of R₃, R₄, R₅, R₆, or R₇ is a polymer; in certain embodiments, two of R₃, R₄, R₅, R₆, or R₇ are each independently a polymer; in certain embodiments, three of R₃, R₄, R₅, R₆, or R₇ are each independently a polymer; in certain embodiments, four of R₃, R₄, R₅, R₆, or R₇ are each independently a polymer; and in certain embodiments, R₃, R₄, R₅, R₆, and R₇ are each independently a polymer. The polymers can be the same or different. The polymers can have the same or different molecular weights. The polymers can each be independently selected from, for example, polycarbonates, polyamides, polyethers, polyurethanes, polyolefins, polyacrylates, and/or polyacrylamides. For example, each polymer can be independently selected from a poly(ε-caprolactone), an polylactic acid (PLA), an acrylonitrile butadiene styrene (ABS), a polyvinyl alcohol, a nylon, and/or a polyethylene glycol.

In some embodiments, R₈, R₉, R₁₀, and R₁₁ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₈, R₉, R₁₀, or R₁₁ is a polymer, or
two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer.

In some embodiments, R₈, R₉, R₁₀, and R₁₁ are each independently selected from H, C₁₋₆ alkyl, C₁₋₆ alkoxy, halo, C₁₋₆ haloalkyl, C₁₋₆ haloalkoxy, and a polymer, provided that at least one of R₈, R₉, R₁₀, or R₁₁ is a polymer, or
two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer.

In some embodiments, R₈, R₉, R₁₀, and R₁₁ are each independently selected from H, C₁₋₆ alkyl, and a polymer, provided that at least one of R₈, R₉, R₁₀, or R₁₁ is a polymer, or
two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer.

In some embodiments, R₈, R₉, R₁₀, and R₁₁ are each independently selected from H and a polymer, provided that at least one of R₈, R₉, R₁₀, or R₁₁ is a polymer, or two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer.

In some embodiments, R₈, R₉, R₁₀, and R₁₁ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₈, R₉, R₁₀, or R₁₁ is a polymer.

In some embodiments, R₈, R₉, R₁₀, and R₁₁ are each independently selected from H, C₁₋₆ alkyl, C₁₋₆ alkoxy, halo, C₁₋₆ haloalkyl, C₁₋₆ haloalkoxy, and a polymer, provided that at least one of R₈, R₉, R₁₀, or R₁₁ is a polymer.

In some embodiments, R₈, R₉, R₁₀, and R₁₁ are each independently selected from H, C₁₋₆ alkyl, and a polymer, provided that at least one of R₈, R₉, R₁₀, or R₁₁ is a polymer.

In some embodiments, R₈, R₉, R₁₀, and R₁₁ are each independently selected from H and a polymer, provided that at least one of R₈, R₉, R₁₀, or R₁₁ is a polymer.

In any of the embodiments above pertaining to R₈, R₉, R₁₀, and R₁₁: in certain embodiments, one of R₈, R₉, R₁₀, and R₁₁ is a polymer; in certain embodiments, two of R₈, R₉, R₁₀, and R₁₁ are each independently a polymer; in certain embodiments, three of R₈, R₉, R₁₀, and R₁₁ are each independently a polymer; and in certain embodiments, R₈, R₉, R₁₀, and R₁₁ are each independently a polymer. The polymers can be the same or different. The polymers can have the same or different molecular weights. The polymers can each be independently selected from, for example, polycarbonates, polyamides, polyethers, polyurethanes, polyolefins, polyacrylates, and/or polyacrylamides. For example, each polymer can be independently selected from a poly(ε-caprolactone), an polylactic acid (PLA), an acrylonitrile butadiene styrene (ABS), a polyvinyl alcohol, a nylon, and/or a polyethylene glycol.

In some embodiments, R₁₂ and R₁₃ are each independently selected from H, C₁₋₆ alkyl, C₁₋₆ alkoxy, aryl, heteroaryl, halo, C₁₋₆ haloalkyl, and C₁₋₆ haloalkoxy.

In some embodiments, R₁₂ and R₁₃ are each independently selected from H, C₁₋₆ alkyl, C₁₋₆ alkoxy, halo, C₁₋₆ haloalkyl, and C₁₋₆ haloalkoxy.

In some embodiments, R₁₂ and R₁₃ are each independently selected from H and C₁₋₆ alkyl.

In some embodiments, R₁₂ and R₁₃ are each independently selected from C₁₋₆ alkyl.

In some embodiments, R₁₂ and R₁₃ are each H.

It is understood that any of the above embodiments for the definitions of R₁ and R₂; R₃, R₄, R₅, R₆, and R₇; R₈, R₉, R₁₀, and R₁₁; and R₁₂ and R₁₃ can be combined to provide the structures as illustrated in Scheme 1.

For example, in some embodiments, R₁ and R₂ are each independently selected from H and C₁₋₆ alkyl;
R₃, R₄, R₅, R₆, and R₇ are each independently selected from H, C₁₋₆ alkyl, and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer;
R₈, R₉, R₁₀, and R₁₁ are each independently selected from H, C₁₋₆ alkyl, and a polymer, provided that at least one of R₈, R₉, R₁₀, or R₁₁ is a polymer, or
two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer; and
R₁₂ and R₁₃ are each independently selected from H and C₁₋₆ alkyl.

In some embodiments, R₁ and R₂ are each independently selected from H and C₁₋₆ alkyl;
R₃, R₄, R₅, R₆, and R₇ are each independently selected from H and a polymer, provided that at least one of R₃, R₄, R₅, R₆, or R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer;
R₈, R₉, R₁₀, and R₁₁ are each independently selected from H and a polymer, provided that at least one of R₈, R₉, R₁₀, or R₁₁ is a polymer, or
two adjacent R₈, R₉, R₁₀, or R₁₁ together with the carbons to which they are attached form aryl or heteroaryl, provided that at least said aryl or heteroaryl is substituted with one or more polymers or at least one of the remaining R₈, R₉, R₁₀, and R₁₁ not part of said aryl or heteroaryl is a polymer; and
R₁₂ and R₁₃ are each independently selected from H and C₁₋₆ alkyl.

In some embodiments, R₁ and R₂ are each independently selected from H and C₁₋₆ alkyl;
R₃, R₄, R₅, R₆, and R₇ are each independently selected from H, C₁₋₆ alkyl, and a polymer, provided that at least one of R₃, R₄, R₅, R₆, or R₇ is a polymer;
R₈, R₉, R₁₀, and R₁₁ are each independently selected from H, C₁₋₆ alkyl, and a polymer, provided that at least one of R₈, R₉, R₁₀, or R₁₁ is a polymer; and
R₁₂ and R₁₃ are each independently selected from H and C₁₋₆ alkyl.

In some embodiments, R₁ and R₂ are each independently selected from H and C₁₋₆ alkyl;
R₃, R₄, R₅, R₆, and R₇ are each independently selected from H and a polymer, provided that at least one of R₃, R₄, R₅, R₆, or R₇ is a polymer;
R₈, R₉, R₁₀, and R₁₁ are each independently selected from H and a polymer, provided that at least one of R₈, R₉, R₁₀, or R₁₁ is a polymer; and
R₁₂ and R₁₃ are each independently selected from H and C₁₋₆ alkyl.

Naphthopyran Moiety

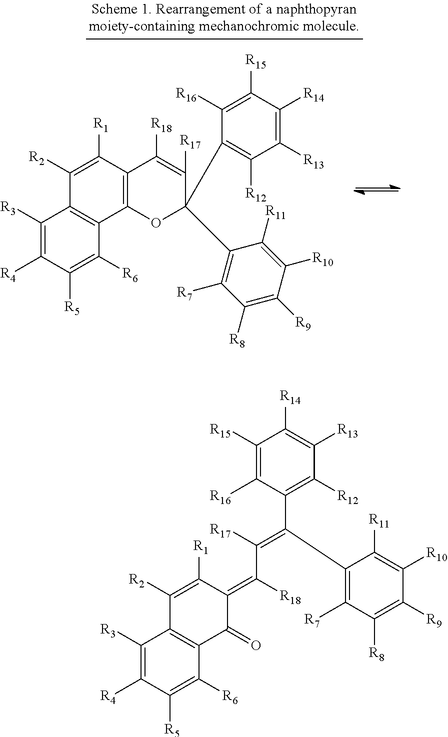

wherein in Scheme 2:
R₁, R₂, R₃, R₄, R₅, and R₆ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer;
R₇, R₈, R₉, R₁₀, R₁₁, R₁₂, R₁₃, R₁₄, R₁₅, and R₁₆ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer; and
R₁₇ and R₁₈ are each independently selected from H, C₁₋₆ alkyl, C₁₋₆ alkoxy, C₂₋₆ alkenyl, C₂₋₆ alkynyl, aryl, heteroaryl, halo, C₁₋₆ haloalkyl, and C₁₋₆ haloalkoxy.

In some embodiments, R₁, R₂, R₃, R₄, R₅, and R₆ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer.

In some embodiments, R₁, R₂, R₃, R₄, R₅, and R₆ are each independently selected from H, C₁₋₆ alkyl, C₁₋₆ alkoxy, halo, C₁₋₆ haloalkyl, C₁₋₆ haloalkoxy, and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer.

In some embodiments, R₁, R₂, R₃, R₄, R₅, and R₆ are each independently selected from H, C₁₋₆ alkyl, and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer.

In some embodiments, R₁, R₂, R₃, R₄, R₅, and R₆ are each independently selected from H and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer.

In some embodiments, R₁, R₂, R₃, R₄, R₅, and R₆ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₁, R₂, R₃, R₄, R₅, and R₆ is a polymer.

In some embodiments, R₁, R₂, R₃, R₄, R₅, and R₆ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₁, R₂, R₃, R₄, R₅, and R₆ is a polymer.

In some embodiments, R₁, R₂, R₃, R₄, R₅, and R₆ are each independently selected from H, C₁₋₆ alkyl, C₁₋₆ alkoxy, halo, C₁₋₆ haloalkyl, C₁₋₆ haloalkoxy, and a polymer, provided that at least one of R₁, R₂, R₃, R₄, R₅, and R₆ is a polymer.

In some embodiments, R₁, R₂, R₃, R₄, R₅, and R₆ are each independently selected from H, C₁₋₆ alkyl, and a polymer, provided that at least one of R₁, R₂, R₃, R₄, R₅, and R₆ is a polymer.

In some embodiments, R₁, R₂, R₃, R₄, R₅, and R₆ are each independently selected from H and a polymer, provided that at least one of R₁, R₂, R₃, R₄, R₅, and R₆ is a polymer.

In any of the embodiments above pertaining to R₁, R₂, R₃, R₄, R₅, and R₆: in certain embodiments, one of R₁, R₂, R₃, R₄, R₅, and R₆ is a polymer; in certain embodiments, two of R₁, R₂, R₃, R₄, R₅, and R₆ are each independently a polymer; in certain embodiments, three of R₁, R₂, R₃, R₄, R₅, and R₆ are each independently a polymer; in certain embodiments, four of R₁, R₂, R₃, R₄, R₅, and R₆ are each independently a polymer; in certain embodiments, five of R₁, R₂, R₃, R₄, R₅, and R₆ are each independently a polymer, and in certain embodiments, R₁, R₂, R₃, R₄, R₅, and R₆ are each independently a polymer. The polymers can be the same or different. The polymers can have the same or different molecular weights. The polymers can each be independently selected from, for example, polycarbonates, polyamides, polyethers, polyurethanes, polyolefins, polyacrylates, and/or polyacrylamides. For example, each polymer can be independently selected from a poly(ε-caprolactone), an polylactic acid (PLA), an acrylonitrile butadiene styrene (ABS), a polyvinyl alcohol, a nylon, and/or a polyethylene glycol.

In some embodiments, R₇, R₈, R₉, R₁₀, R₁₁, R₁₂, R₁₃, R₁₄, R₁₅, and R₁₆ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer.

In some embodiments, R₇, R₈, R₉, R₁₀, R₁₁, R₁₂, R₁₃, R₁₄, R₁₅, and R₁₆ are each independently selected from H, C₁₋₆ alkyl, C₁₋₆ alkoxy, halo, C₁₋₆ haloalkyl, C₁₋₆ haloalkoxy, and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer.

In some embodiments, R₇, R₈, R₉, R₁₀, R₁₁, R₁₂, R₁₃, R₁₄, R₁₅, and R₁₆ are each independently selected from H, C₁₋₆ alkyl, and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer.

In some embodiments, R₇, R₈, R₉, R₁₀, R₁₁, R₁₂, R₁₃, R₁₄, R₁₅, and R₁₆ are each independently selected from H and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer.

In some embodiments, R₇, R₈, R₉, R₁₀, R₁₁, R₁₂, R₁₃, R₁₄, R₁₅, and R₁₆ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₇, R₈, R₉, R₁₀, R₁₁, R₁₂, R₁₃, R₁₄, R₁₅, and R₁₆ is a polymer.

In some embodiments, R₇, R₈, R₉, R₁₀, R₁₁, R₁₂, R₁₃, R₁₄, R₁₅, and R₁₆ are each independently selected from H, C₁₋₆ alkyl, C₁₋₆ alkoxy, halo, C₁₋₆ haloalkyl, C₁₋₆ haloalkoxy, and a polymer, provided that at least one of R₇, R₈, R₉, R₁₀, R₁₁, R₁₂, R₁₃, R₁₄, R₁₅, and R₁₆ is a polymer.

In some embodiments, R₇, R₈, R₉, R₁₀, R₁₁, R₁₂, R₁₃, R₁₄, R₁₅, and R₁₆ are each independently selected from H, C₁₋₆ alkyl, and a polymer, provided that at least one of R₇, R₈, R₉, R₁₀, R₁₁, R₁₂, R₁₃, R₁₄, R₁₅, and R₁₆ is a polymer.

In some embodiments, R₇, R₈, R₉, R₁₀, R₁₁, R₁₂, R₁₃, R₁₄, R₁₅, and R₁₆ are each independently selected from H and a polymer, provided that at least one of R₇, R₈, R₉, R₁₀, R₁₁, R₁₂, R₁₃, R₁₄, R₁₅, and R₁₆ is a polymer.

In any of the embodiments above pertaining to R₇, R₈, R₉, R₁₀, R₁₁, R₁₂, R₁₃, R₁₄, R₁₅, and R₁₆: in certain embodiments, one of R₇, R₈, R₉, R₁₀, R₁₁, R₁₂, R₁₃, R₁₄, R₁₅, and R₁₆ is a polymer; in certain embodiments, two of R₇, R₈, R₉, R₁₀, R₁₁, R₁₂, R₁₃, R₁₄, R₁₅, and R₁₆ are each independently a polymer; in certain embodiments, three of R₇, R₈, R₉, R₁₀, R₁₁, R₁₂, R₁₃, R₁₄, R₁₅, and R₁₆ are each independently a polymer; in certain embodiments, four of R₇, R₈, R₉, R₁₀, R₁₁, R₁₂, R₁₃, R₁₄, R₁₅, and R₁₆ are each independently a polymer; and in certain embodiments, five of R₇, R₈, R₉, R₁₀, R₁₁, R₁₂, R₁₃, R₁₄, R₁₅, and R₁₆ are each independently a polymer. The polymers can be the same or different. The polymers can have the same or different molecular weights. The polymers can each be independently selected from, for example, polycarbonates, polyamides, polyethers, polyurethanes, polyolefins, polyacrylates, and/or polyacrylamides. For example, each polymer can be independently selected from a poly(ε-caprolactone), an polylactic acid (PLA), an acrylonitrile butadiene styrene (ABS), a polyvinyl alcohol, a nylon, and/or a polyethylene glycol.

In some embodiments, R₁₇ and R₁₈ are each independently selected from H, C₁₋₆ alkyl, C₁₋₆ alkoxy, aryl, heteroaryl, halo, C₁₋₆ haloalkyl, and C₁₋₆ haloalkoxy.

In some embodiments, R₁₇ and R₁₈ are each independently selected from H, C₁₋₆ alkyl, C₁₋₆ alkoxy, halo, C₁₋₆ haloalkyl, and C₁₋₆ haloalkoxy.

In some embodiments, R₁₇ and R₁₈ are each independently selected from H and

C₁₋₆ alkyl.

In some embodiments, R₁₇ and R₁₈ are each independently selected from C₁₋₆ alkyl.

In some embodiments, R₁₇ and R₁₈ are each H.

It is understood that any of the above embodiments for the definitions of R₁, R₂, R₃, R₄, R₅, and R₆; R₇, R₈, R₉, R₁₀, R₁₁, R₁₂, R₁₃, R₁₄, R₁₅, and R₁₆; and R₁₇ and R₁₈ can be combined to provide the structures as illustrated in Scheme 2.

For example, in some embodiments, R₁, R₂, R₃, R₄, R₅, and R₆ are each independently selected from H, C₁₋₆ alkyl, and a polymer, provided that at least one of R₁, R₂, R₃, R₄, R₅, and R₆ is a polymer;
R₇, R₈, R₉, R₁₀, R₁₁, R₁₂, R₁₃, R₁₄, R₁₅, and R₁₆ are each independently selected from H, C₁₋₆ alkyl, and a polymer, provided that at least one of R₇, R₈, R₉, R₁₀, R₁₁, R₁₂, R₁₃, R₁₄, R₁₅, and R₁₆ is a polymer; and
R₁₇ and R₁₈ are each independently selected from H and C₁₋₆ alkyl.

In some embodiments, R₁, R₂, R₃, R₄, R₅, and R₆ are each independently selected from H and a polymer, provided that at least one of R₁, R₂, R₃, R₄, R₅, and R₆ is a polymer;
R₇, R₈, R₉, R₁₀, R₁₁, R₁₂, R₁₃, R₁₄, R₁₅, and R₁₆ are each independently selected from H and a polymer, provided that at least one of R₇, R₈, R₉, R₁₀, R₁₁, R₁₂, R₁₃, R₁₄, R₁₅, and R₁₆ is a polymer; and
R₁₇ and R₁₈ are each independently selected from H and C₁₋₆ alkyl.

In some embodiments, R₁, R₂, R₃, R₄, R₅, and R₆ are each independently selected from H, C₁₋₆ alkyl, and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer;
R₇, R₈, R₉, R₁₀, R₁₁, R₁₂, R₁₃, R₁₄, R₁₅, and R₁₆ are each independently selected from H, C₁₋₆ alkyl, and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer; and
R₁₇ and R₁₈ are each independently selected from H and C₁₋₆ alkyl.

In some embodiments, R₁, R₂, R₃, R₄, R₅, and R₆ are each independently selected from H and a polymer, provided that at least one of R₁, R₂, R₃, R₄, R₅, and R₆ is a polymer, or
two adjacent R₁, R₂, R₃, R₄, R₅, or R₆ together with the carbons to which they are attached form aryl or heteroaryl, provided that at least said aryl or heteroaryl is substituted with one or more polymers or at least one of the remaining R₁, R₂, R₃, R₄, R₅, and R₆ not part of said aryl or heteroaryl is a polymer;
R₇, R₈, R₉, R₁₀, R₁₁, R₁₂, R₁₃, R₁₄, R₁₅, and R₁₆ are each independently selected from H and a polymer, provided that at least one of R₇, R₈, R₉, R₁₀, R₁₁, R₁₂, R₁₃, R₁₄, R₁₅, and R₁₆ is a polymer, or
two adjacent R₇, R₈, R₉, R₁₀, or R₁₁ together with the carbons to which they are attached form aryl or heteroaryl, provided that at least said aryl or heteroaryl is substituted with one or more polymers or at least one of the remaining R₇, R₈, R₉, R₁₀, and R₁₁ not part of said aryl or heteroaryl is a polymer, or
two adjacent R₁₂, R₁₃, R₁₄, R₁₅, or R₁₆ together with the carbons to which they are attached form aryl or heteroaryl, provided that at least said aryl or heteroaryl is substituted with one or more polymers or at least one of the remaining R₁₂, R₁₃, R₁₄, R₁₅, and R₁₆ not part of said aryl or heteroaryl is a polymer; and
R₁₇ and R₁₈ are each independently selected from H and C₁₋₆ alkyl.

Spirooxazine Moiety

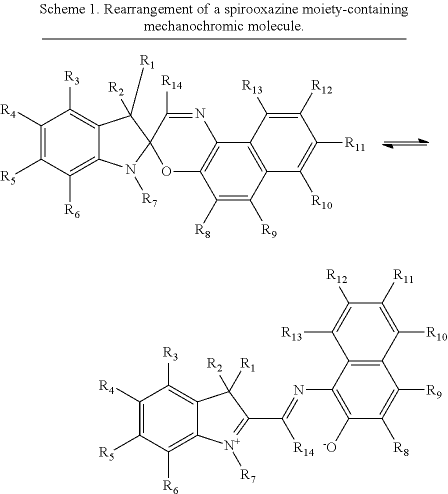

wherein in Scheme 3:
R₁ and R₂ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy;
R₃, R₄, R₅, R₆, and R₇ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer;
R₈, R₉, R₁₀, R₁₁, R₁₂, and R₁₃ are each independently selected from H, C₁₋₆ alkyl, C₂₋₆ alkenyl, C₂₋₆ alkynyl, C₁₋₆ alkoxy, aryl, heteroaryl, halo, C₁₋₆ haloalkyl, C₁₋₆ haloalkoxy, and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer; and
R₁₄ is selected from H, C₁₋₆ alkyl, C₁₋₆ alkoxy, C₂₋₆ alkenyl, C₂₋₆ alkynyl, aryl, heteroaryl, halo, C₁₋₆ haloalkyl, and C₁₋₆ haloalkoxy.

In some embodiments, R₁ and R₂ are each independently selected from H, C₁₋₆ alkyl, C₁₋₆ alkoxy, aryl, heteroaryl, halo, C₁₋₆ haloalkyl, and C₁₋₆ haloalkoxy.

In some embodiments, R₁ and R₂ are each independently selected from H, C₁₋₆ alkyl, C₁₋₆ alkoxy, halo, C₁₋₆ haloalkyl, and C₁₋₆ haloalkoxy.

In some embodiments, R₁ and R₂ are each independently selected from H and C₁₋₆ alkyl.

In some embodiments, R₁ and R₂ are each independently selected from C₁₋₆ alkyl.

In some embodiments, R₁ and R₂ are each H.

In some embodiments, R₃, R₄, R₅, R₆, and R₇ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H, C₁₋₆ alkyl, C₁₋₆ alkoxy, halo, C₁₋₆ haloalkyl, C₁₋₆ haloalkoxy, and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H, C₁₋₆ alkyl, and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer.

In some embodiments, R₃, R₄, R₅, R₆, and R₇ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₃, R₄, R₅, R₆, and R₇ is a polymer.

In some embodiments, R₃, R₄, R₅, R₆, and R₇ are each independently selected from H, C₁₋₆ alkyl, C₁₋₆ alkoxy, halo, C₁₋₆ haloalkyl, C₁₋₆ haloalkoxy, and a polymer, provided that at least one of R₃, R₄, R₅, R₆, and R₇ is a polymer.

In some embodiments, R₃, R₄, R₅, R₆, and R₇ are each independently selected from H, C₁₋₆ alkyl, and a polymer, provided that at least one of R₃, R₄, R₅, R₆, and R₇ is a polymer.

In some embodiments, R₃, R₄, R₅, R₆, and R₇ are each independently selected from H and a polymer, provided that at least one of R₃, R₄, R₅, R₆, and R₇ is a polymer.

In any of the embodiments above pertaining to R₃, R₄, R₅, R₆, and R₇: in certain embodiments, one of R₃, R₄, R₅, R₆, and R₇ is a polymer; in certain embodiments, two of R₃, R₄, R₅, R₆, and R₇ are each independently a polymer; in certain embodiments, three of R₃, R₄, R₅, R₆, and R₇ are each independently a polymer; in certain embodiments, four of R₃, R₄, R₅, R₆, and R₇ are each independently a polymer; and in certain embodiments, each of R₃, R₄, R₅, R₆, and R₇ is independently a polymer. The polymers can be the same or different. The polymers can have the same or different molecular weights. The polymers can each be independently selected from, for example, polycarbonates, polyamides, polyethers, polyurethanes, polyolefins, polyacrylates, and/or polyacrylamides. For example, each polymer can be independently selected from a poly(ε-caprolactone), an polylactic acid (PLA), an acrylonitrile butadiene styrene (ABS), a polyvinyl alcohol, a nylon, and/or a polyethylene glycol.

In some embodiments, R₈, R₉, R₁₀, R₁₁, R₁₂, and R₁₃ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer.

In some embodiments, R₈, R₉, R₁₀, R₁₁, R₁₂, and R₁₃ are each independently selected from H, C₁₋₆ alkyl, C₁₋₆ alkoxy, halo, C₁₋₆ haloalkyl, C₁₋₆ haloalkoxy, and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer.

In some embodiments, R₈, R₉, R₁₀, R₁₁, R₁₂, and R₁₃ are each independently selected from H, C₁₋₆ alkyl, and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer.

In some embodiments, R₈, R₉, R₁₀, R₁₁, R₁₂, and R₁₃ are each independently selected from H and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer.

In some embodiments, R₈, R₉, R₁₀, R₁₁, R₁₂, and R₁₃ are each independently selected from H, C₁₋₆ alkyl, C₁₋₆ alkoxy, aryl, heteroaryl, halo, C₁₋₆ haloalkyl, C₁₋₆ haloalkoxy, and a polymer, provided that at least one of R₈, R₉, R₁₀, R₁₁, R₁₂, and R₁₃ is a polymer.

In some embodiments, R₈, R₉, R₁₀, R₁₁, R₁₂, and R₁₃ are each independently selected from H, C₁₋₆ alkyl, C₁₋₆ alkoxy, halo, C₁₋₆ haloalkyl, C₁₋₆ haloalkoxy, and a polymer, provided that at least one of R₈, R₉, R₁₀, R₁₁, R₁₂, and R₁₃ is a polymer.

In some embodiments, R₈, R₉, R₁₀, R₁₁, R₁₂, and R₁₃ are each independently selected from H, C₁₋₆ alkyl, and a polymer, provided that at least one of R₈, R₉, R₁₀, R₁₁, R₁₂, and R₁₃ is a polymer.

In some embodiments, R₈, R₉, R₁₀, R₁₁, R₁₂, and R₁₃ are each independently selected from H and a polymer, provided that at least one of R₈, R₉, R₁₀, R₁₁, R₁₂, and R₁₃ is a polymer.

In any of the embodiments above pertaining to R₈, R₉, R₁₀, R₁₁, R₁₂, and R₁₃: in certain embodiments, one of R₈, R₉, R₁₀, R₁₁, R₁₂, and R₁₃ is a polymer; in certain embodiments, two of R₈, R₉, R₁₀, R₁₁, R₁₂, and R₁₃ are each independently a polymer; in certain embodiments, three of R₈, R₉, R₁₀, R₁₁, R₁₂, and R₁₃ are each independently a polymer; in certain embodiments, four of R₈, R₉, R₁₀, R₁₁, R₁₂, and R₁₃ are each independently a polymer; in certain embodiments, five of R₈, R₉, R₁₀, R₁₁, R₁₂, and R₁₃ are each independently a polymer; and in certain embodiments, each of R₈, R₉, R₁₀, R₁₁, R₁₂, and R₁₃ is independently a polymer. The polymers can be the same or different. The polymers can have the same or different molecular weights. The polymers can each be independently selected from, for example, polycarbonates, polyamides, polyethers, polyurethanes, polyolefins, polyacrylates, and/or polyacrylamides. For example, each polymer can be independently selected from a poly(ε-caprolactone), an polylactic acid (PLA), an acrylonitrile butadiene styrene (ABS), a polyvinyl alcohol, a nylon, and/or a polyethylene glycol.

In some embodiments, R₁₄ is selected from H, C₁₋₆ alkyl, C₁₋₆ alkoxy, aryl, heteroaryl, halo, C₁₋₆ haloalkyl, and C₁₋₆ haloalkoxy.

In some embodiments, R₁₄ is selected from H, C₁₋₆ alkyl, C₁₋₆ alkoxy, halo, C₁₋₆ haloalkyl, and C₁₋₆ haloalkoxy.

In some embodiments, R₁₄ is selected from H and C₁₋₆ alkyl.

In some embodiments, R₁₄ is C₁₋₆ alkyl.

In some embodiments, R₁₄ is H.

It is understood that any of the above embodiments for the definitions of R₁ and R₂; R₃, R₄, R₅, R₆, and R₇; R₈, R₉, R₁₀, R₁₁, R₁₂, and R₁₃; and R₁₄ can be combined to provide the structures as illustrated in Scheme 3.

For example, in some embodiments, R₁ and R₂ are each independently selected from H and C₁₋₆ alkyl;
R₃, R₄, R₅, R₆, and R₇ are each independently selected from H, C₁₋₆ alkyl, and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer;
R₈, R₉, R₁₀, R₁₁, R₁₂, and R₁₃ are each independently selected from H, C₁₋₆ alkyl, and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer; and
R₁₄ is selected from H and C₁₋₆ alkyl.

In some embodiments, R₁ and R₂ are each independently selected from H and C₁₋₆ alkyl;
R₃, R₄, R₅, R₆, and R₇ are each independently selected from H and a polymer, provided that at least one of R₃, R₄, R₅, R₆, and R₇ is a polymer, or
two adjacent R₃, R₄, R₅, R₆, or R₇ together with the carbons to which they are attached form aryl or heteroaryl, provided that at least said aryl or heteroaryl is substituted with one or more polymers or at least one of the remaining R₃, R₄, R₅, R₆, and R₇ not part of said aryl or heteroaryl is a polymer;
R₈, R₉, R₁₀, R₁₁, R₁₂, and R₁₃ are each independently selected from H and a polymer, provided that at least one of R₈, R₉, R₁₀, R₁₁, R₁₂, and R₁₃ is a polymer, or
two adjacent R₈, R₉, R₁₀, R₁₁, R₁₂, or R₁₃ together with the carbons to which they are attached form aryl or heteroaryl, provided that at least said aryl or heteroaryl is substituted with one or more polymers or at least one of the remaining R₈, R₉, R₁₀, R₁₁, R₁₂, and R₁₃ not part of said aryl or heteroaryl is a polymer; and
R₁₄ is selected from H and C₁₋₆ alkyl.

In some embodiments, R₁ and R₂ are each independently selected from H and C₁₋₆ alkyl;
R₃, R₄, R₅, R₆, and R₇ are each independently selected from H, C₁₋₆ alkyl, and a polymer, provided that at least one of R₃, R₄, R₅, R₆, and R₇ is a polymer;
R₈, R₉, R₁₀, R₁₁, R₁₂, and R₁₃ are each independently selected from H, C₁₋₆ alkyl, and a polymer, provided that at least one of R₈, R₉, R₁₀, R₁₁, R₁₂, and R₁₃ is a polymer; and
R₁₄ is selected from H and C₁₋₆ alkyl.

In some embodiments, R₁ and R₂ are each independently selected from H and C₁₋₆ alkyl;
R₃, R₄, R₅, R₆, and R₇ are each independently selected from H and a polymer, provided that at least one of R₃, R₄, R₅, R₆, and R₇ is a polymer;
R₈, R₉, R₁₀, R₁₁, R₁₂, and R₁₃ are each independently selected from H and a polymer, provided that at least one of R₈, R₉, R₁₀, R₁₁, R₁₂, and R₁₃ is a polymer; and

In some embodiments, R₁₄ is selected from H and C₁₋₆ alkyl.

### Matrix Polymer

The mechanochromic molecule can be blended with a matrix polymer, which can be any polymer that can be used in additive manufacturing. For example, the matrix polymer can include an acrylonitrile butadiene styrene, a poly(lactic acid), a polyamide, a polycarbonate, a polyether, a polyurethane, a polyolefin, a polyacrylate, a polyacrylamide, and/or a polyethylene glycol. In some embodiments, the matrix polymer can include two or more polymers. The mechanochromic molecule can be blended into the matrix polymer in an amount of about 0.001% to 10% (e.g., about 0.01% to 10%, about 0.1% to 10%, about 1% to 10%, about 0.01% to 5%, about 0.1 to 5%, about 1% to 5%) by weight of the mechanochromic molecule. For example, the blend can include about 10% by weight of the mechanochromic molecule.

When the mechanochromic molecule is blended into a matrix polymer, the mechanochromic molecule and the matrix polymer can adopt different morphologies. For example, the mechanochromic molecule and the matrix polymer can be intimately mixed, such that a homogeneous mixture is obtained. In some embodiments, the mechanochromic molecule and the first matrix polymer exhibit macrophase separation. In certain embodiments, the mechanochromic molecule and the first matrix polymer exhibit microphase separation.

### Forms of Deposition Materials

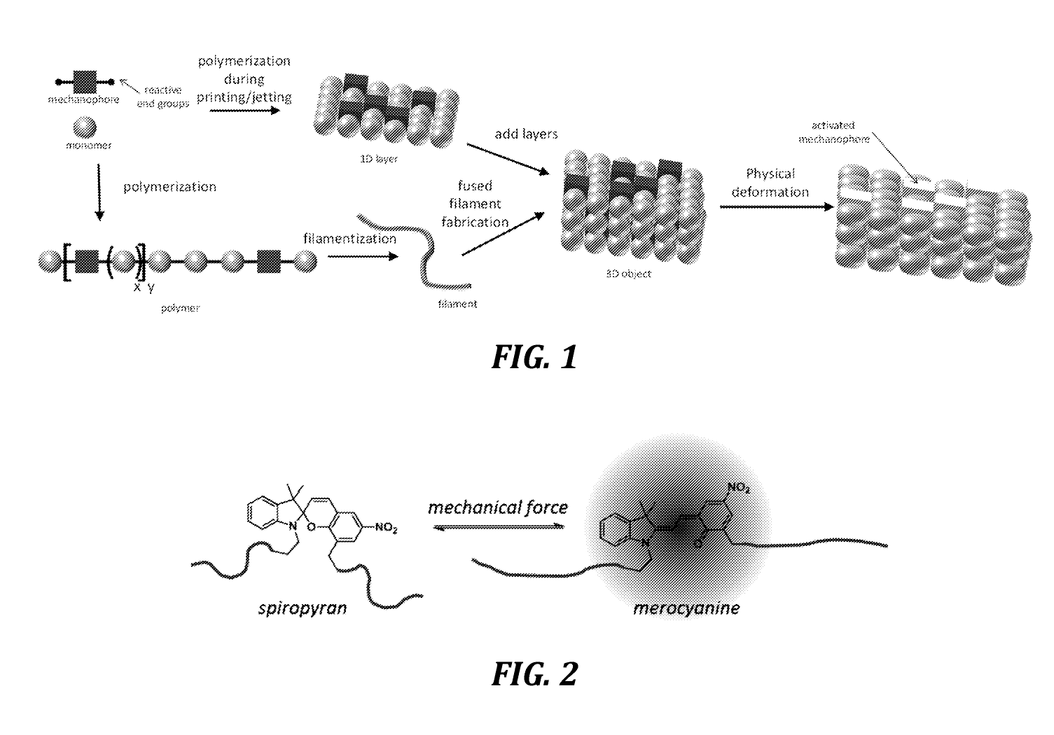

Referring to FIG. 1, the mechanochromic molecule can be formed by polymerization of a mechanochromic initiator having reactive end groups and a monomer. Once formed, the mechanochromic molecule can be blended into a matrix polymer, and the resulting blend can be formed into a variety of shapes suitable for additive manufacturing. For example, the blend can be in the form of a filament (FIG. 1) or a powder.

In some embodiments, the filament can have a diameter of about 1.5 mm to 3.0 mm and/or a length of from 1 to 100 feet. In some embodiments, the filament diameter can vary along a length. The filament can be made, for example, by milling a blend of a mechanochromic molecule and a matrix polymer, then extruding the milled blend to form a filament. The filament can be used, for example, in extrusion-based processes such as FFF, as shown in FIG. 1.

In some embodiments, the powder can have a diameter of about 10 μm to 100 μm (e.g., about 20 μm to 100 μm, about 20 μm to 80 μm, or about 20 μm to 60 μm). A population of powder can have a relatively homogenous diameter that varies by less than 20 percent (e.g., less than 10 percent, less than 5 percent, or less than 2 percent). In some embodiments, a population of powder can have particles of different sizes. The powder can be made, for example, by milling a blend of a mechanochromic molecule and a matrix polymer. The powder can be used, for example, in selective laser sintering processes.

### Blends Formed by In Situ Polymerization

In some embodiments, rather than forming a blend with a mechanochromic molecule and one or more matrix polymers and then producing an article from the blend via additive manufacturing. The blend can be formed from the polymerization of mechanochromic molecule precursors (i.e., a mechanochromic initiator and one or more types of monomers to form the mechanochromic molecule) and the polymerization of matrix polymer precursors (i.e., initiators and one or more types of monomers to form the matrix polymer). In some embodiments, the blend can be formed in situ from mechanochromic molecule precursors and from matrix polymer precursors during additive manufacturing.

For example, the additive manufacturing method can include exposing to a stimulus a mixture including a mechanochromic initiator having at least two initiation groups, one or more monomers capable of being covalently bound to each of the initiation groups of the mechanochromic initiator, and one or more monomers capable of forming a matrix polymer. The stimulus can activate the mechanochromic initiator and start the polymerization of the one or more monomers (capable of being covalently bound to each of the initiation groups of the mechanochromic initiator) at each of the two initiator groups on the mechanochromic initiator. The stimulus can also activate a separate initiator for the matrix polymer, and form the matrix polymer by polymerization of the one or more monomers capable of forming a matrix polymer. In some embodiments, the polymerization can take place in a vat containing mixture of the mechanochromic initiator, one or more monomers capable of being covalently bound to each of the initiation groups of the mechanochromic initiator, and one or more monomers capable of forming a matrix polymer, in a selective light modulation additive manufacturing process (discussed above), where a stimulus can be projected onto the mixture, polymerization of the monomers can occur at the stimulus-exposed surface, and a polymerized article can be built up in a layer by layer manner. Thus, a polymerized article can be made from the vat of polymer precursors by in situ polymerization. The polymerized article can then be removed from the mixture. In some embodiments, rather than placing the mixture and polymerizing the mixture in a vat, the mixture can be sprayed from a nozzle by a jetting process as shown in FIG. 1, and the sprayed mixture can be exposed to a stimulus to polymerize the initiators and monomers and form the article in a layer by layer manner.

The stimulus to trigger polymerization of the mechanochromic molecule and the matrix polymer can take a variety of forms, such as an electromagnetic radiation (e.g., UV, near-UV, or visible light of from about 250 to 800 nm) and/or heat of up to 50° C., over a period of time of, for example, 1 to 30 seconds (e.g., 1 to 15 seconds, 1 to 20 seconds, 5 to 25 seconds, or 5 to 20 seconds).

In some embodiments, the one or more monomers capable of forming a matrix polymer, when polymerized, provide a matrix polymer selected from polyamide, polycarbonate, polyether, polyurethane, polyolefin, polyacrylate, polyacrylamide, and/or polyethylene glycol. In some embodiments, the one or more monomers capable of forming a matrix polymer, when polymerized, provide a matrix polymer selected from acrylonitrile butadiene styrene, poly(lactic acid), and/or poly(ε-caprolactone).

In some embodiments, the mechanochromic initiator is a spiropyran moiety, a naphthopyran moiety (e.g., an indenonaphthopyran moiety), or a spirooxazine moiety, each having a first end and a second end, and at least two reactive functional groups, where at least one reactive functional group is located at each end of the mechanochromic initiator. In some embodiments, the functional group is an alkene, an acrylate, or an alpha-haloester.

In some embodiments, the one or more monomers capable of being covalently bound to each of the initiation groups of the mechanochromic initiator, when polymerized, provides a polymer covalently bound through each of the initiation groups of the mechanochromic initiator. The polymer covalently bound through each of the initiation groups of the mechanochromic initiator can be polyamide, polycarbonate, polyether, polyurethane, polyolefin, polyacrylate, polyacrylamide, and/or polyethylene glycol. In some embodiments, the polymer covalently bound through each of the initiation groups of the mechanochromic initiator is selected from acrylonitrile butadiene styrene, poly(lactic acid), and/or poly(ε-caprolactone).

### Additive Manufacturing Methods

The additive manufacturing method of the present disclosure can include, for example, selective laser sintering (e.g., for the fusing step), fused filament fabrication (e.g., for the depositing and fusing steps), and jetting the material by material jetting, binder jetting, or inkjet printing (e.g., for the deposition step).

The additive manufacturing method can use commercially available 3D printers, such as those based on filament extrusion technology that can fabricate parts from thermoplastics such as polylactic acid (PLA) and acrylonitrile butadiene styrene (ABS), which can be adapted to print advanced polymers including stimulus-responsive materials of the present disclosure.

For example, the additive manufacturing method can include a system including a filament as described above and a melt extrusion printer. The filament can be used in the printer without damage to the mechanochromic molecules and/or without significant changes to mechanical properties (e.g., tensile modulus, yield strength, strain to break, flexural modulus) of the matrix polymer.

As another example, the additive manufacturing method can include a selective laser sintering method, which can use the powder as described above to make an article without damage to the mechanochromic molecules and/or without significant changes to mechanical properties of the matrix polymer.

### Articles

A variety of articles or devices can be made using the materials described in the present disclosure via additive manufacturing processes. For example, a tensile indication device, including a mechanochromic molecule and a matrix polymer, or mechanochromic regions embedded within a matrix polymer, where a portion or all of the device exhibit color changes in response to mechanical stimulus (e.g., a mechanical stress such as a pressure, pulling, bending, twisting, etc.) can be prepared using the methods of the present disclosure. The color change can be reversible, such that the device can revert to its initial color over time, when the mechanical stimulus is removed.

In some embodiments, the article can be a personal care article, a sensor, an implant, a prosthetic, a protective equipment, and/or a transportation article. For example, the personal care article can be a toothbrush. The sensor can be a bridge sensor, a mechanical stress sensor. The implant can be a dental implant. The protective equipment can be a helmet. The transportation article can be a tire.

The articles made from the materials of the present disclosure using additive manufacturing processes can have numerous advantages. For example, a toothbrush having bristles formed of a mechanochromic molecule and a matrix polymer can change color if a user applies too much pressure when brushing teeth. The color change can be reversible so that the toothbrush can reusable.

In some embodiments, the amount of mechanical stress that is applied to an article can be quantified. For example, the color of a mechanochromic region in an article that has been subjected to mechanical stress can be compared to a calibration curve, which can correlate mechanical stress to color intensity, thereby providing an estimate of the mechanical stress that was applied. As another example, the amount of mechanical stress that is applied to an article can be compared to the amount of mechanical stress that is applied to another article by comparing the color intensity and/or region of color change of the two articles, where increased color intensity and/or region of color change indicates a greater amount of mechanical stress.

In some embodiments, the article/device can include a mixture of regions, such as regions that are mechanochromic and regions that can change color when exposed to heat and/or light.

In some embodiments, the article including the mechanochromic molecule or a portion of an article including the mechanochromic molecule is integrally embedded in a host polymer (e.g., a second matrix polymer) to form a device, such that the embedded article or the embedded portion of the article cannot be removed from the second matrix polymer without destroying the initial structure. The device including the host polymer can be simultaneously made by an additive manufacturing process such that there is little segregation and/or defects between the embedded article and the host polymer.

When the mechanochromic molecule is blended into a matrix polymer and incorporated into an article, the mechanochromic molecule and the matrix polymer can be intimately mixed, such that a homogeneous mixture is obtained. In some embodiments, the mechanochromic molecule and the first matrix polymer exhibit macrophase separation when incorporated into an article. In certain embodiments, the mechanochromic molecule and the first matrix polymer exhibit microphase separation when incorporated into an article.

The following examples are provided to illustrate, not limit, the invention.

Example 1 describes the synthesis and characterization of filaments including poly(ε-caprolactone) and a spiropyran mechanophore using a commercial fused filament fabrication printer. Tensile test specimens containing various spiropyran concentrations, spiropyran control molecules, multiple materials, or mechanoresponsive regions embedded within the specimen were prepared and subjected to tensile testing. The materials exhibit distinct color changes that were attributed to mechanochemical isomerization of the spiropyran mechanophore. Example 2 describes the 3D printing of mechanoresponsive polymers. Mechanoresponsive regions within tensile or fracture test specimens were activated upon tensile elongation. A prototype force sensor was developed. The force sensor enabled the rapid visual determination of the amount of force being applied to the specimen.

### Examples

### Example 1. 3-D Printed Mechanoresponsive Materials

The ability to incorporate mechanochemically-responsive units into materials amenable to 3DP techniques to produce printed objects with well-defined shapes and regions capable of chemo-mechanical coupling was evaluated. Mechanochromic spiropyran systems were studied, because of the ease of determining qualitative activation in these systems. Upon application of force across the Cₛₚᵢᵣₒ—O bond, isomerization of the spiropyran to its highly colored merocyanine isomer can be accomplished (FIG. 2).

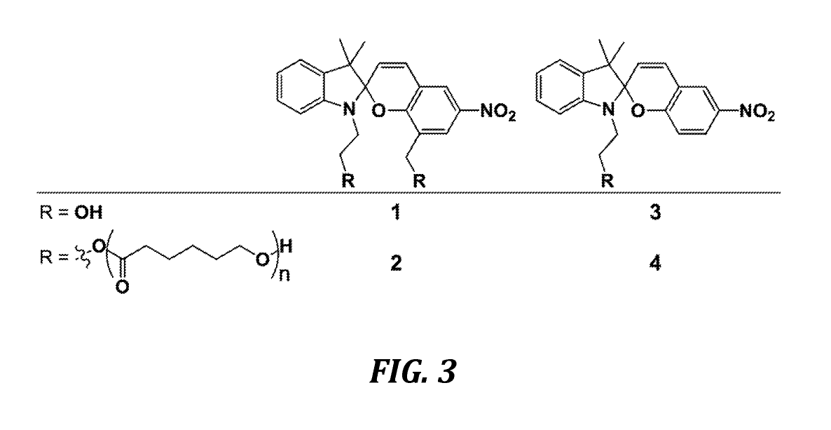

A thermoplastic polymer was used with FFF printing, where the polymer filament was first melted in an extrusion head and subsequently deposited according to the software provided to the printer. Thus, two spiropyran moieties, 1 and 3 (shown in FIG. 3), were prepared and used as bi- or mono-directional initiators, respectively, for the ring opening polymerization of ε-caprolactone. Polymer 2 (M_{w}=90 kDa, D=1.16) bore a chain-centered spiropyran such that elongation of the polymer resulted in stress accumulation across the desired Cₛₚᵢᵣₒ—O bond, and isomerization was activated. In contrast, polymer 4 (M_{w}=65 kDa, D=1.43) had a chain-end spiropyran moiety such that stress would not be accumulated across the necessary bond, and thus it should not be activated by mechanical stimulus. Notably, each of these polymers had molecular weights that were sufficiently greater than the limiting molecular weight necessary for achieving mechanochemical activation. Each polymer was blended with commercial poly(ε-caprolactone) (C) at various concentrations (Table 1) and then the blended materials were ground into small particles (<5 mm diameter) prior to filament formation for FFF. The wt % of each spiropyran-containing polymer was denoted by the subscript (e.g., 2₁₀ is comprised of 10 wt % 2 and 90 wt % C).

TABLE 1
Molecular weight and dispersity data for the synthesized and
commercial polymer, and compositions of the filament types.

| | | | | | Spiropyran |
|---|---|---|---|---|---|
| | | M_{w} | | | Concentration |
| Filament | Polymer | (kDa) | PDI | Blend | (% w/w) |
| 2₁₀ | 2 | 90 | 1.16 | 10% w/w with C | 0.05 |
| 2₅₀ | | | | 50% w/w with C | 0.25 |
| 2₁₀₀ | | | | none | 0.5 |
| 4₅₀ | 4 | 65 | 1.43 | 50% w/w with C | 0.39 |
| C₁₀₀ | C | 63 | 1.29 | none | none |

Filament was prepared using a single screw melt extruder. Average filament diameters ranged from about 1.55 to 1.85 mm, with variation along the filament typically being less than ±0.05 mm. To ensure the most accurate diameter, each sample of filament was measured with calipers in multiple places along the section to be used for printing and the average diameter was used in the print parameters.

The custom filaments were then used to print tensile testing specimens using a commercial dual-extrusion head FFF printer. Printing was initially performed using only one of the extrusion heads set at a temperature of 110° C., a non-heated build plate, and a print speed of 20 mm/s. Due to the relatively flexible nature of the filament, disabling retraction (a setting that reverses the drive gear in the extruder head to pull the filament back into the nozzle, which is used to combat filament oozing) was key to being able to successfully print full specimens without the filament jamming. During the printing, no thermal activation of the spiropyran was observed.

### Synthetic Procedures and Testing Conditions

General Considerations

Dry toluene was obtained from a Glass Contour solvent purification system. The monomer ε-caprolactone was dried over 4 Å molecular sieves for 48 h prior to use. House N₂ was passed through a drying tube before use. All other reagents and solvents were used as obtained from commercial sources. ¹H spectra were recorded on Bruker AVance 300 and 500 MHz spectrometers. Chemical shifts are reported in delta (δ) units, expressed in parts per million (ppm) downfield from tetramethylsilane using the residual protio-solvent as an internal standard (CDCl₃, ¹H: 7.26 ppm). GPC setup consisted of: a Shimadzu pump, three in-line MZ Analysentechnik columns, DAWN Heleos II multi-angle laser light scattering and T-rEX refractive index detectors (Wyatt Technology Corporation), and DMF (0.01 M LiBr) as the mobile phase.

Abbreviations

DMF=N,N-dimethylformamide; GPC=gel permeation chromatography; Oct=2-ethylhexanoate

Synthetic Procedures

Synthesis of Polymers:

Initiators 1 and 3 were prepared as described in O'Bryan, G. et al., ACS Appl. Mater. Inter. 2010, 2, 1594 and Raymo, F. M.; Giordani, S. J. Am. Chem. Soc. 2001, 123, 4651. Synthesis of polymer 2 was carried out following a procedure as described in O'Bryan, G. et al., ACS Appl. Mater. Inter. 2010, 2, 1594.

Polymer 4 was prepared with an analogous procedure to that of 2. Specifically, a flame-dried and N₂-purged three-neck round bottom flask fitted with a reflux condenser was charged with initiator 3 (268 mg, 0.76 mmol, 1.0 mol. equiv.) and a stir bar. To the reaction flask was then added ε-caprolactone (29.4 mL, 265 mmol, 350 mol. equiv.) and dry toluene (30.0 mL). Finally, Sn(Oct)₂ (80 μL, 0.251 mmol, 0.33 mol. equiv.) was added and the reaction solution was brought to refluxing temperature. After 24 h, the reaction solution was cooled to 40° C., diluted with toluene (˜150 mL), and stirred until the polymer was fully dissolved. The polymer solution was then precipitated into cold MeOH, after which the precipitate was dried under reduced pressure. The product was obtained as a brown solid in 96% yield (29.0 g).

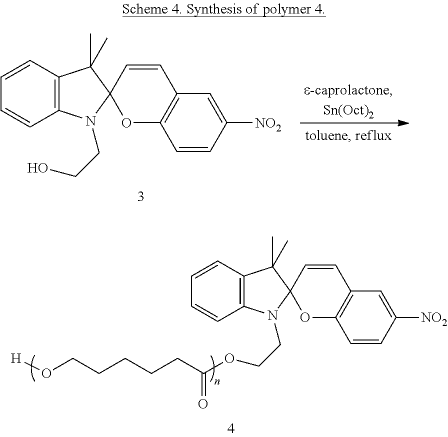

Polymer 2 was characterized by ¹H NMR in CDCl₃. GPC characterization of Polymer 2 showed a M_{w} of 90 kDa, PDI 1.16. Polymer 4 was characterized by ¹H NMR in CDCl₃. GPC characterization of Polymer 4 showed a M_{w} of 65 kDa, PDI 1.43. Makerbot Flexible Filament (C) was characterized by ¹H NMR in CDCl₃. GPC characterization of Makerbot Flexible Filament (C) showed a M_{w} of 63 kDa, PDI 1.29.

Filament Production:

Polymers 2 and 4 were mixed with C (Makerbot Flexible Filament cut into small pieces), melted with a heat gun, and manually mixed with a spatula. The resulting mixture was cut into small pieces with scissors and put into a coffee grinder with dry ice. The polymer was ground into small particles/powder and made into filament via melt extrusion (at 63° C.) with a Filabot Wee filament extruder. The filament 2₁₀₀ was produced without blending any commercial filament.

3D Printing:

3D structures were designed using Sketchup 2013 computer aided design (CAD) software and converted to .stl files using a Sketchup extension. The .stl files were imported into Replicator G (version 0040) and gcode (for Makerbot-type printers) was generated using either Sli3er 0.X (for single material prints) or Skeingforge 50 (for multi-material prints) slicing programs. For multi-material prints, gcode from each .stl file was merged in Replicator G. A Flashforge Creator dual head FFF 3D printer (firmware 7.2) was used to read the gcode and print the 3D object. Objects were printed onto a non-heated Plexiglas build plate. The extrusion nozzle was heated to 110° C. All print speeds were set to 20 mm/s, with a travel speed of 50 mm/s and retraction disabled when applicable. All objects were printed with 2 shells, a fill density of 1 (100% fill), and a layer height of 0.25 mm. Filament diameters were determined prior to each print by measuring with calipers.

Mechanical Testing:

Tensile testing of printed specimens was performed on an Instron 5500R load frame controlled using Bluehill 2 software. Load was measured with a 5 kN load cell. Tests were conducted using a crosshead rate of 100 mm/min. Dimensions of each specimen were measured with calipers prior to testing to ensure accurate calculation of stress and strain for each sample. Three specimens were tested for a given filament type.

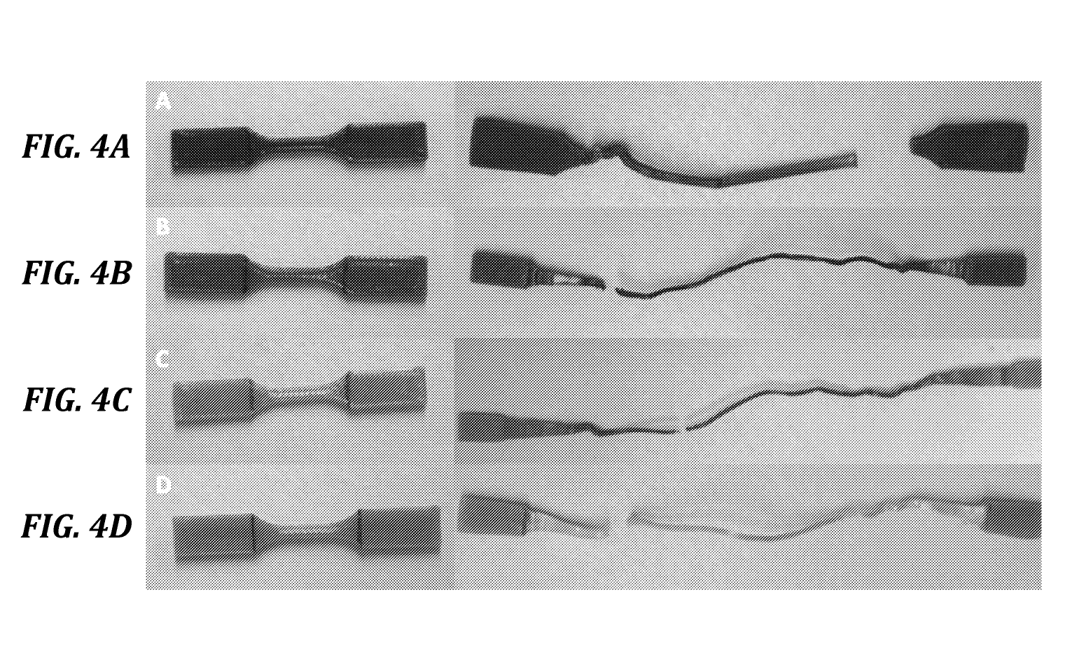

To examine the basic mechanical properties of the materials and ensure a controlled environment for elongation, tensile testing was completed on an Instron load frame. In all cases in which 2 was present, color change from brown to purple was observed upon elongation and necking of the sample, signifying mechanochemical activation of the spiropyran. While the intensity of the resulting color was directly related to the amount of 2 used in the blend, the greatest contrast between virgin and elongated (activated) materials was observed for blends having lower loading of spiropyran, due to the lighter color of the unactivated material (FIGS. 4A-4C). Although the Young's modulus and yield strength of each of the blended materials was found to be lower than that of the non-blends (Table 2), all are in good agreement with reported values for poly(ε-caprolactone). No spiropyran activation was observed in the test specimens made from 4₅₀ (FIG. 4D) tested under the same conditions, confirming the mechanical origin of the color change.

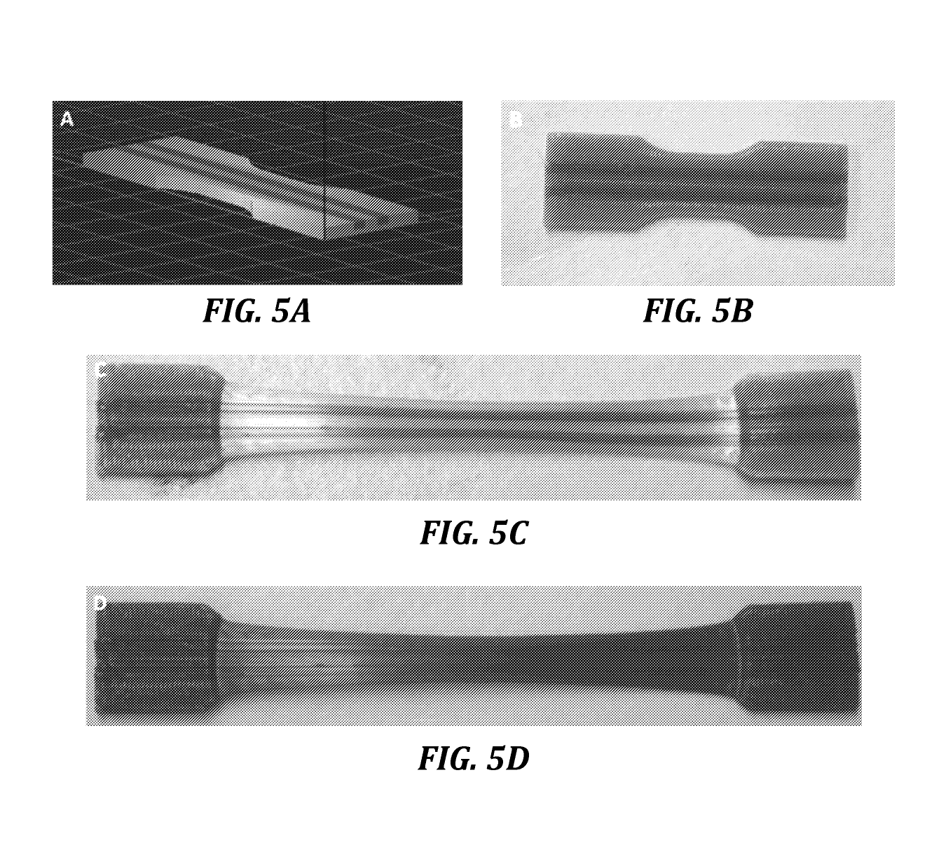

Binary materials were then prepared that highlight the capabilities of 3DP in contrast with other types of traditional manufacturing methods, such as injection or compression molding. A dual-responsive tensile test specimen including discrete regions of mechanoresponsive 2₅₀ and control filament 4₅₀ was printed in a single session by using two extrusion heads, each loaded with one of the filament types. With a dual extrusion technique, the active print head alternates such that only one head is printing at a time. The test specimen body was comprised mainly of 4₅₀ which was used as a housing around two surface channels of 2₅₀ that spanned the length of the printed specimen (FIGS. 5A-5B). Upon elongation of the sample, only the regions containing 2₅₀ were activated, consistent with prior observations in homogeneous specimens made of either 2₅₀ or 4₅₀ (FIG. 5C). Notably, the spiropyran moieties in both materials were still susceptible to UV-triggered isomerization. Thus, illumination with 365 nm light from a handheld UV lamp led to spiropyran activation and color change throughout the test specimen (FIG. 5D).

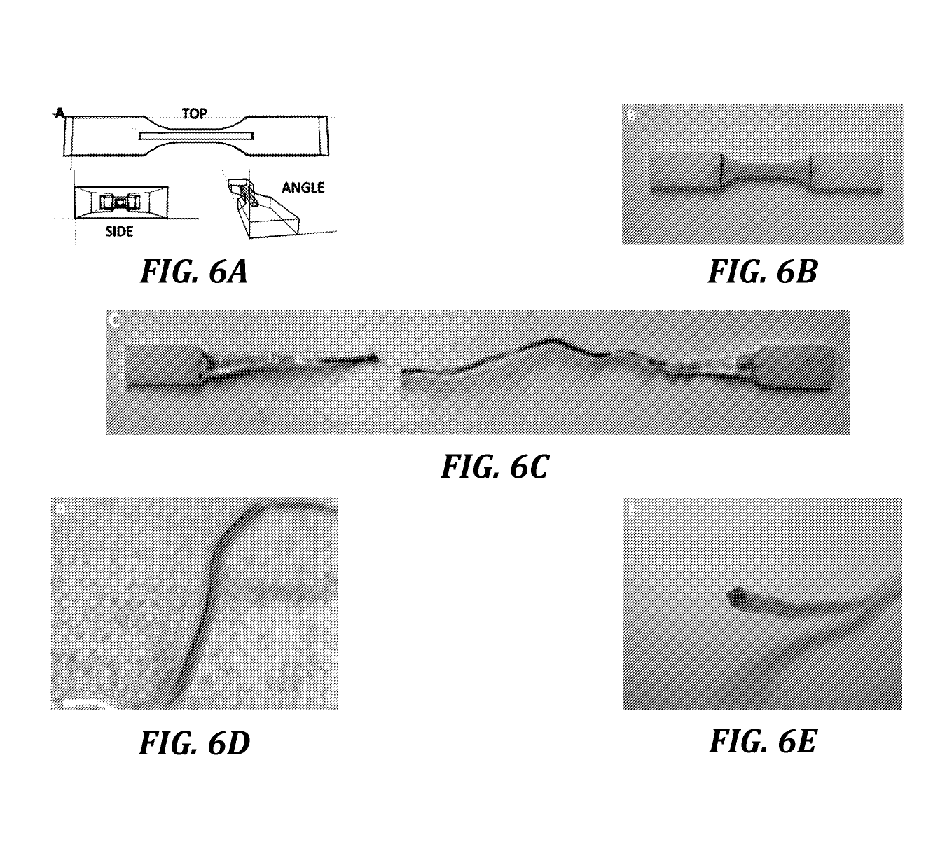

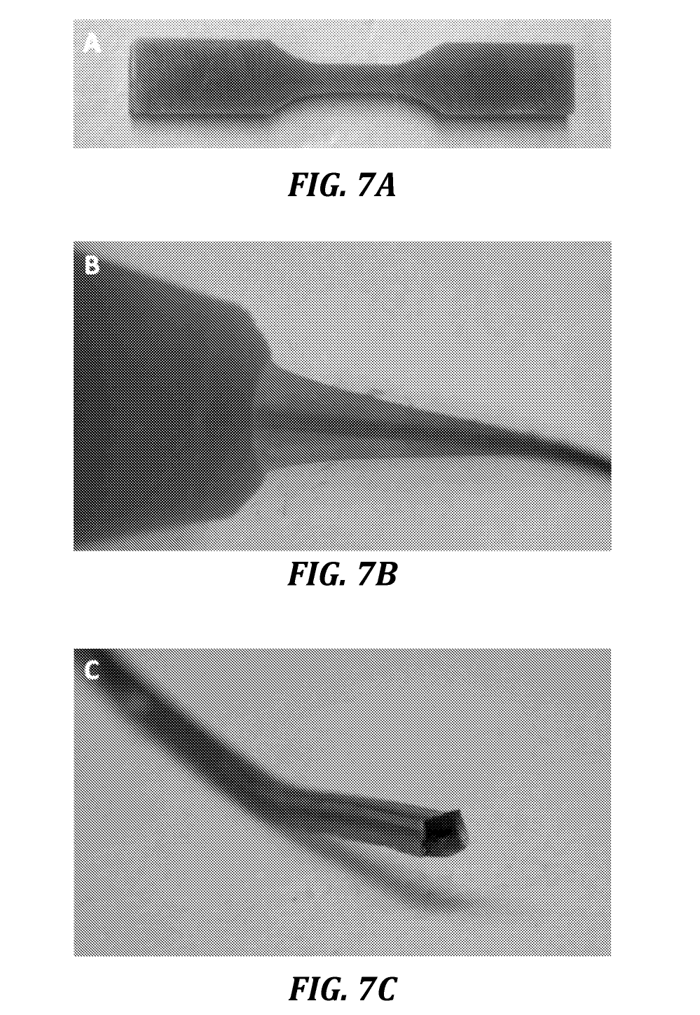

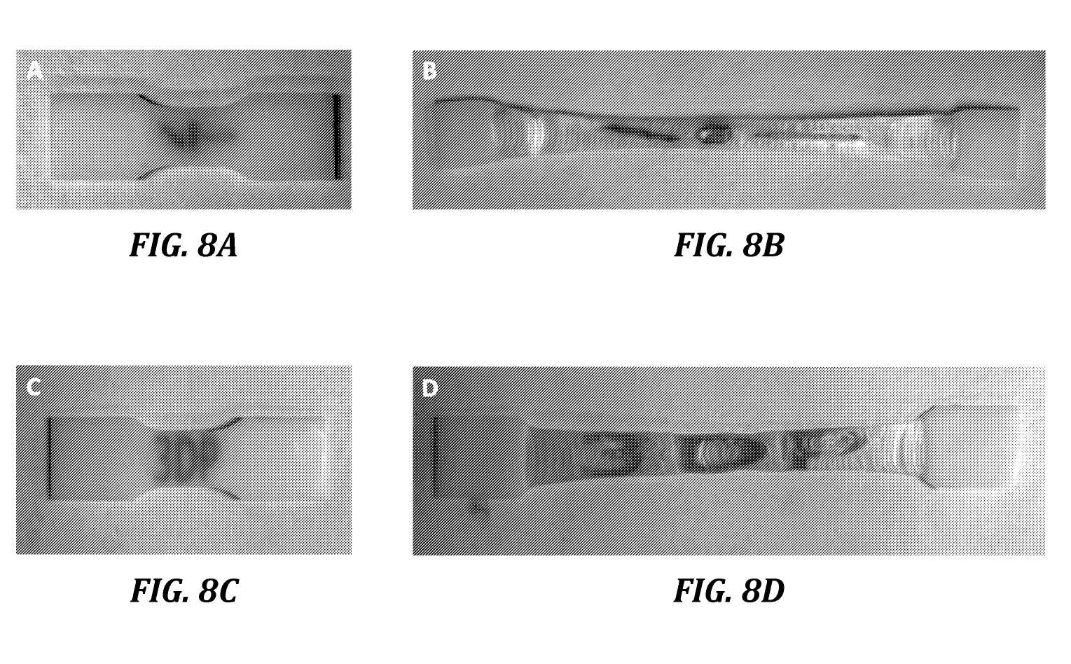

The use of 3DP was then explored to prepare objects in which a rectangular region of mechanoresponsive 2₅₀ was completely encased by C₁₀₀ (FIGS. 6A-6E), a type of structure that would be difficult (if not impossible) to prepare in a single operation via injection molding. Using the dual extrusion method, the target configuration was printed in a single session and then subjected to elongation as before. The 2₅₀ region was again selectively activated and the color change was visible from the exterior of the material (FIGS. 6C-6E). The materials properties of this specimen design were similar to the specimens comprised solely of C (Table 2), indicating good adhesion of the two different components. Using the same print code and replacing the commercial filament (C) with control filament 4₅₀ as the encasing material resulted in a sample in which the 2₅₀ region was not visible prior to elongation (FIG. 7A). Upon tensile testing, the mechanoresponsive core became clearly distinguishable from the encasing filament (FIGS. 7B-7C). Test specimens in which multiple embedded 2₅₀ regions of different shapes and orientations were also prepared (FIGS. 8A-8D), further highlighting the technical advantages offered by 3DP for preparing advanced material compositions.

TABLE 2
Summary of the materials properties of the test specimens
prepared from the various filament types. Values are an
average of three experiments ± one standard deviation.

| | | Yield | Tensile | % |
|---|---|---|---|---|
| Filament | Modulus | Strength | Strength | elongation |
| Type | (Gpa) | (Mpa) | (Mpa) | to break |
| C₁₀₀ | 0.336 ± 0.042 | 16.57 ± 0.20 | 33.24 ± 1.15 | 709 ± 25 |
| 2₁₀ | 0.268 ± 0.029 | 13.32 ± 0.42 | 29.50 ± 1.12 | 750 ± 81 |
| 2₅₀ | 0.300 ± 0.003 | 14.56 ± 0.48 | 27.17 ± 1.94 | 664 ± 37 |
| 2₁₀₀ | 0.351 ± 0.030 | 17.49 ± 0.24 | 14.86 ± 1.71 | 302 ± 12 |
| 4₅₀ | 0.300 ± 0.067 | 15.00 ± 0.21 | 26.82 ± 0.31 | 651 ± 12 |
| 2₅₀ encased | 0.308 ± 0.045 | 15.96 ± 0.83 | 33.15 ± 1.61 | 716 ± 56 |
| in C₁₀₀ | | | | |

Thus, Example 1 demonstrates the successful 3D printing of mechanoresponsive polymers. The basic mechanical properties of the different structures prepared with various filament formulations showed some variation, but were within the range of reported values for poly(ε-caprolactone). With the use of a dual-head FFF printer, dual-responsive materials with segregated stimuli-responsive regions were produced, in which only one component activated in response to elongational force but both did so when exposed to UV irradiation. The use of 3DP enabled rapid production of binary materials such as encased mechanoresponsive materials within commercial or control polymers. These materials would generally be difficult or impossible to prepare with other manufacturing techniques.

### Example 2. Prototype Force Sensors

Example 2 provides smart materials that respond with changes in chemical properties. “Chemically activated” is used herein to indicate a chemical stimulus and “chemically responsive” is used herein to indicate a chemical response or output (to any variety of stimulus). Here, mechanically activated, chemically responsive smart materials, which incorporated molecules that underwent chemical reactions in response to mechanical forces, were used. These mechanically-activated molecules or moieties are referred to herein as “mechanophores.”

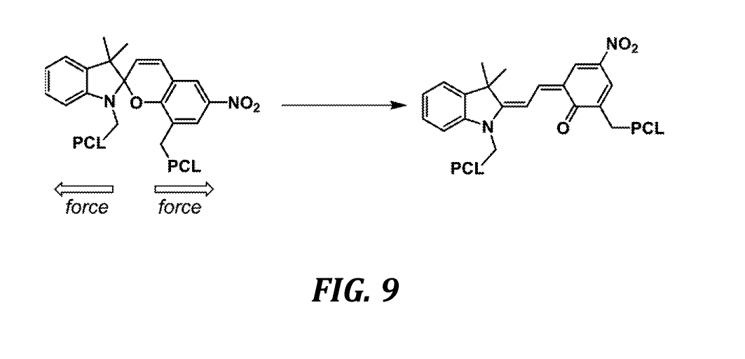

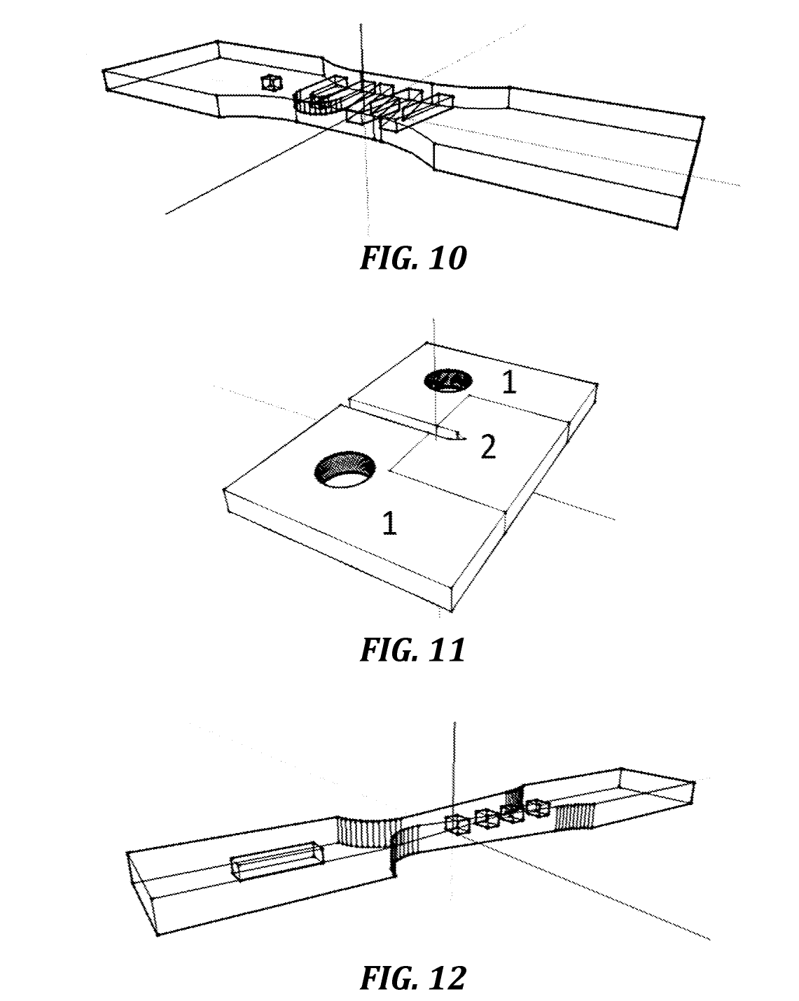

A mechanochromic spiropyran (SP) was used, which provided easily discernable chemical output based upon a distinct color change. As shown in FIG. 9, when subjected to mechanical tensile strain imposed by elongation of flanking polymer chains, the SP mechanophore can undergo a ring opening reaction to generate a merocyanine chromophore, which manifests an intense purple color. SP chromophores have well established mechanochromic properties and, as shown in FIG. 10, can be combined with polycaprolactone (PCL), which can be used as a flexible filament for fused-filament systems.

The fabrication of SP/PCL filaments was demonstrated, and the filaments were applicable for FFF and the mechanophoric properties were preserved during the additive manufacturing process. Spatially-controlled mechanical activation and chemical response were demonstrated using a dual-filament system to produce sample “smart parts” for mechanical testing. Experimental results to characterize the behavior of the “smart parts” under crack opening were presented. Finally, 3D printed sensors based on mechanophoric smart part technology were also presented.

Custom PCL including covalently incorporated SP (SP/PCL) was synthesized. The custom polymer was mixed with commercial PCL filament (Makerbot Flexible Filament) to decrease the spiropyran content of the material. Samples were produced with 1%, 3%, 5%, 10%, 20%, or 50% w/w SP/PCL filament blended with commercial filament. The SP mechanophore accounts for a small fraction of the SP/PCL filament, such that using 1% w/w of SP/PCL filament in the blend results in a final concentration of SP mechanophores of 0.005% w/w relative to total PCL. The samples were melted with a heat gun and manually mixed with a spatula. The melting and mixing process was repeated at least once more to ensure visual homogeneity. An aliquot of the mixed sample was melted and formed into a 1.5 cm long “cigar” shape. Samples were manually elongated with pliers to observe the mechanochemical color change. The elongated samples were additionally subjected to 365 nm ultraviolet (UV) irradiation from a hand held UV lamp to observe the photochromism of the SP (Minkin 2004).

The mechanoresponsive SP/PCL and commercial PCL filament (chopped into pieces 2-3 cm in length) were mixed at the desired weight percentage. They were then melted together and mixed manually with a spatula. After cooling, the mixture was cut into small pieces and ground into a powder containing smaller pieces no bigger than 5 mm in diameter using an electronically controlled burr mill containing dry ice. The resulting material was filamentized using a Filabot Wee filament extruder set at 63° C.

3D objects were designed using Sketchup 2013 computer aided design (CAD) software and converted to .stl files using a Sketchup extension. Part descriptions were exported in .STL format and imported into Replicator G version 0040 (Replicator G is a program that is used to manipulate and move the 3D object on the build plate, interface with the slicing programs, control/drive the 3D printer, etc.) and G-code (for Makerbot-type printers) was generated using the Skeinforge 50 slicing program. For multi-material prints, G-code from each .STL file was merged in Replicator G. In reading the G-code scripts and 3D printing the objects, a dual head Flashforge Creator FFF printer (with firmware 7.2) was used. A non-heated Plexiglas build plate was used as the printing surface. The extrusion nozzle was heated to 110° C. All print speeds were set to 20 mm/s, with a travel speed of 20 mm/s. All parts were printed with 2 shells, a fill density of 1 (100% fill), and a layer height of 0.25 mm.

### Stretching Letters Embedded in Dogbone Shaped Specimen

Mechanoresponsive material (50% blend) in the shape of the letters “UW” was encased within a tensile test specimen of commercial filament (FIG. 10). Elongation of the specimen was completed with an Instron 5500R load frame controlled using Bluehill 3.0 software, equipped with a 5 kN load cell, and using a crosshead rate of 100 mm/min.

### Tensile Testing of Center-Cracked Specimens

The geometry of the notched specimen prepared for Mode-I loading (opening mode) is shown in FIG. 11. Tensioning of fractured specimens was performed on an Instron 5585H 250 kN electro-mechanical test frame. Load was measured with a 2.5 kN load cell. A tensile displacement rate of 20 mm/min was prescribed.

### 3D Printed Force Sensor

The force sensor was comprised of commercial filament with embedded mechanoresponsive material (50% blend) as depicted in FIG. 12. Tensile testing of the printed specimen was performed on an Instron 5500R load frame controlled using Bluehill 3.0 software. Load was measured with a 5 kN load cell. Tests were conducted using a crosshead rate of 100 mm/min.

### Results

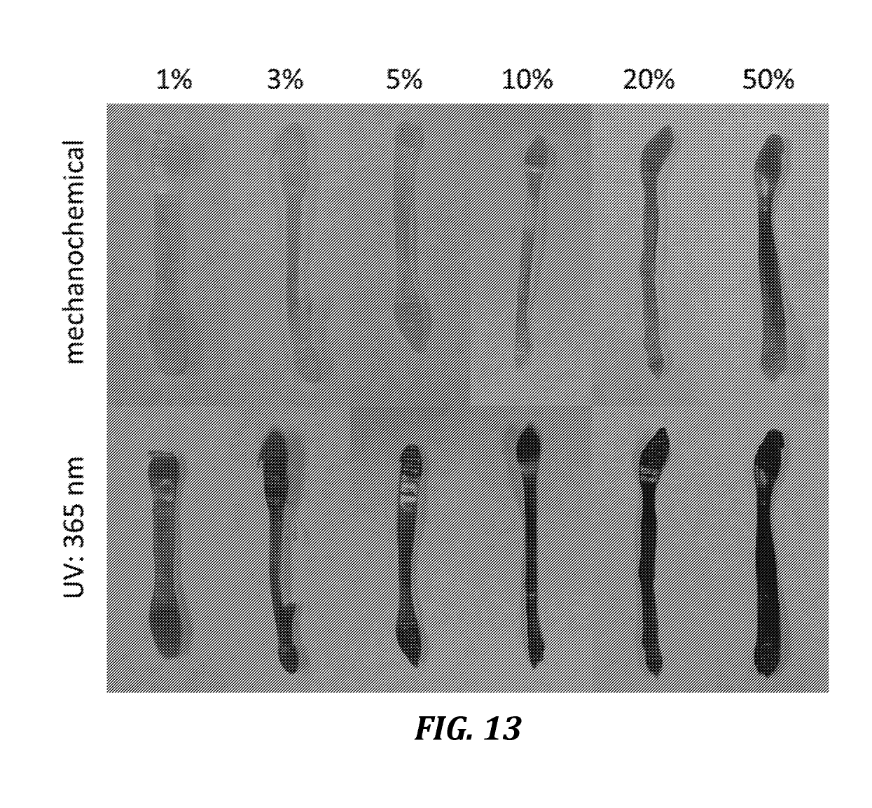

As the SP mechanophore was not as readily available as the bulk PCL and requires several synthetic steps to produce, the minimum SP concentration needed to be able to observe the mechanochromic response visually without additional analytical techniques was explored. To decrease the SP concentration, the mechanoresponsive polymer was blended with commercial PCL. The mechanochromism was observable using 3% w/w of the SP/PCL filament, but was not very distinct until the blend reached 10% w/w of SP/PCL (FIG. 13). Notably, the intense photochemical color change confirmed presence of the SP throughout the blended filament.

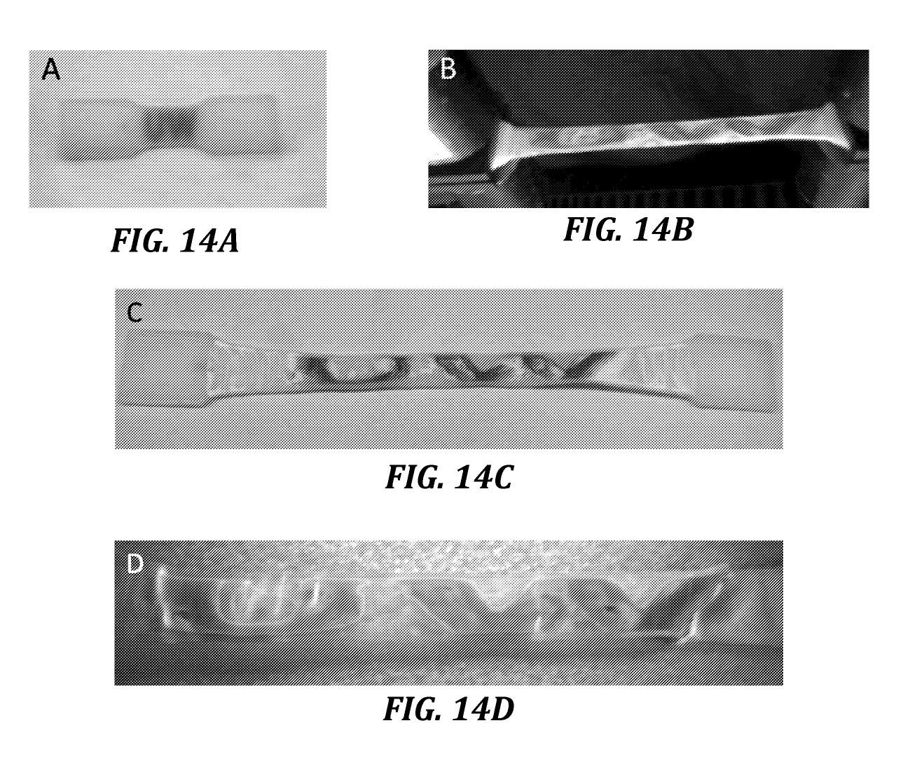

The incorporation of the mechanoresponsive material into a tensile testing specimen was conducted to explore its activation. The mechanoresponsive material can be incorporated into complex architectures. As shown in FIGS. 14A-14D, activation of the mechanoresponsive regions completely embedded within inert polymer was achieved. This demonstration illustrates some of the interesting features of the SP functionalized material. When the mechanoresponsive regions were placed under stress, they appeared blue (FIG. 14B). When the applied force was removed, allowing for the material to relax to its elongated state, the regions appeared purple (FIG. 14C). Additionally, the activated regions became photoluminescent, as shown in FIG. 14D.

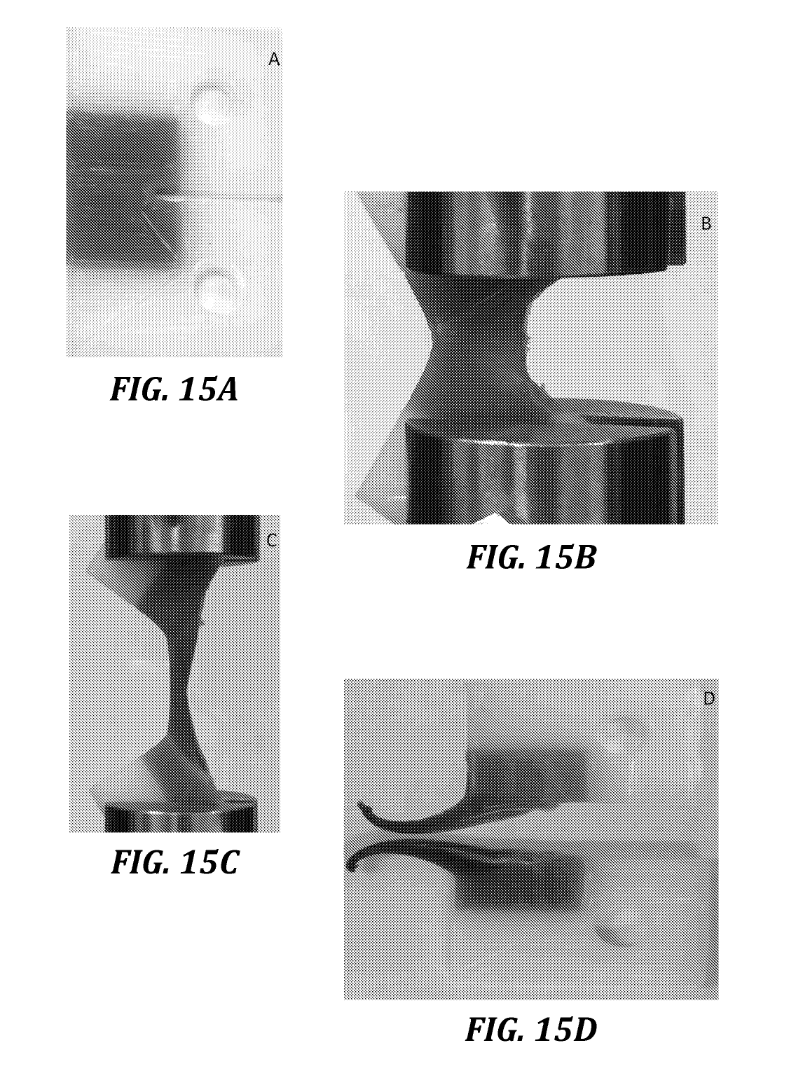

According to the theory of linear elasticity, crack tips are regions where the stress and strain are infinite. Later work shows that although infinite stress and strain are not realistic, the crack tip is the region where each is greatest. Under Mode-I fracture, yield zone forms at the tip of a crack in polymers just like in metals as explained by Anderson (2005). In agreement with this, the state of the specimen before, during, and after the test can be seen in FIGS. 15A-15D. In FIGS. 15B and 15C, the region where the strain was highest was activated and showed a purple color, which was the result of mechanical activation of the SP.

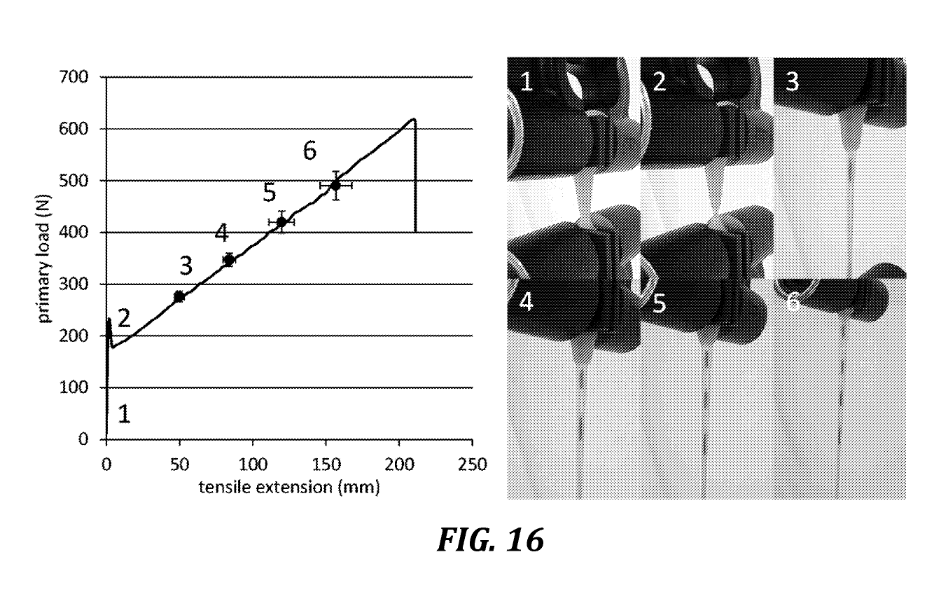

In order to demonstrate a potential application of the mechanoresponsive material, a proof-of-concept force sensor was developed. An asymmetric tensile test specimen was prepared with embedded regions of SP/PCL. A standard “dogbone” specimen displayed a nearly flat stress-strain relation, thus a linear variation of cross section was introduced with the goal of requiring increased load to continue stretching the sample. A linear variation in the width of the specimen successfully produced a stress-strain curve that had a very nearly constant non-zero slope over a wide range of loads (FIG. 16). Upon elongation and necking of the specimen, sequential activation of the embedded SP/PCL regions was observed, with each region corresponding to a specific applied force. This sensor enabled the quick determination of the amount of force applied to the material just by counting the number of activated regions. In this way, the mechanical load could be estimated without any external instrumentation.

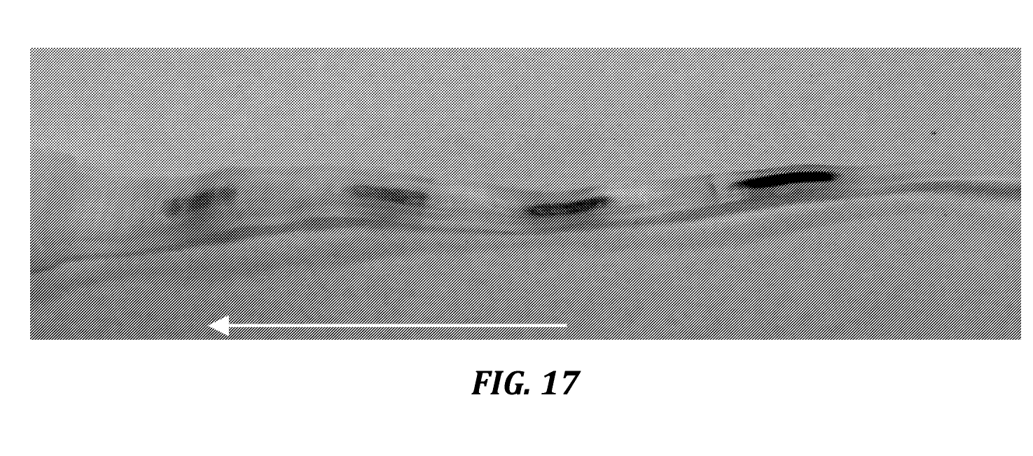

In addition to being able to simply count the number of activated regions, which correlated with the peak load, it could be observed in the post-elongated specimen that the mechanoresponsive regions that activated first were also darker than the regions that activated at a later time (FIG. 17), giving the possibility of determining the amount of force by quantifying the intensity of the purple color.

In summary, 3D printing of mechanoresponsive polymers using an entry-level AM system is demonstrated. Mechanoresponsive regions within tensile or fracture test specimens were activated upon tensile elongation. To demonstrate the potential applications of this material, a prototype force sensor was developed. The force sensor enabled the rapid visual determination of the amount of force being applied to the specimen.

While illustrative embodiments have been illustrated and described, it will be appreciated that various changes can be made therein without departing from the spirit and scope of the invention.

The embodiments of the invention in which an exclusive property or privilege is claimed are defined as follows:

1. An additive manufacturing method, comprising:
depositing onto a substrate a material comprising a blend of a mechanochromic molecule and a matrix polymer; and
fusing the material to provide an article,
wherein the mechanochromic molecule has a first end and a second end and comprises at least one polymer chain covalently bound to each end.

2. The additive manufacturing method of claim 1, wherein the mechanochromic molecule comprises a strained moiety capable of rearranging to a colored moiety.

3. The additive manufacturing method of claim 2, wherein the colored moiety comprises a conjugated planar moiety.

4. The additive manufacturing method of claim 1, wherein the mechanochromic molecule comprises a spiropyran moiety, a naphthopyran moiety, an indenonaphthopyran moiety, or a spirooxazine moiety.

5. The additive manufacturing method of claim 2, wherein the mechanochromic molecule rearranges to a colored molecule upon relief of a strain in the strained moiety.

6. The additive manufacturing method of claim 1, wherein fusing the material comprises selective laser sintering.

7. The additive manufacturing method of claim 1, wherein depositing and fusing the material comprises fused filament fabrication.

8. The additive manufacturing method of claim 1, wherein depositing the material comprises jetting the material.

9. The additive manufacturing method of claim 1, wherein the matrix polymer is selected from an acrylonitrile butadiene styrene, a poly(lactic acid), a polyamide, a polycarbonate, a polyether, a polyurethane, a polyolefin, a polyacrylate, a polyacrylamide, and a polyethylene glycol.

10. An additive manufacturing method, comprising:
exposing a mixture comprising a mechanochromic initiator having at least two initiation groups, a first monomer capable of being covalently bound to each of the initiation groups of the mechanochromic initiator, and a second monomer capable of forming a matrix polymer when exposed to a stimulus; and
polymerizing the monomers to provide a polymerized article.

11. The additive manufacturing method of claim 10, further comprising removing the polymerized article from the mixture.

12. The additive manufacturing method of claim 10, wherein the second monomer, when polymerized, provides a matrix polymer selected from a polyamide, a polycarbonate, a polyether, a polyurethane, a polyolefin, a polyacrylate, a polyacrylamide, and a polyethylene glycol.

13. The additive manufacturing method of claim 10, wherein the second monomer, when polymerized, provides a matrix polymer selected from an acrylonitrile butadiene styrene, a poly(lactic acid), and a poly(c-caprolactone).

14. The additive manufacturing method of claim 10, wherein the mechanochromic initiator is selected from a spiropyran, an indenonaphthopyran, and a spirooxazine, the mechanochromic initiator having at least two reactive functional groups.

15. The additive manufacturing method of claim 10, wherein the first monomer, when polymerized, provides a polymer covalently bound through each of the initiation groups of the mechanochromic initiator.

16-17. (canceled)

18. The additive manufacturing method of claim 10, wherein the stimulus is light, heat, or both light and heat.

19-20. (canceled)

21. An article, comprising a blend of a mechanochromic molecule and a first matrix polymer, wherein the mechanochromic molecule comprises a strained moiety capable of rearranging to a colored moiety, the mechanochromic molecule further has a first end and a second end and comprises at least one polymer chain covalently bound to each end.

22. The article of claim 21, wherein the article is selected from a filament, a particle, a personal care article, a sensor, an implant, a prosthetic, a protective equipment, and a transportation article.

23-29. (canceled)

30. The article of claim 21, wherein the article is integrally embedded in a second matrix polymer.

31. The article of claim 21, wherein the mechanochromic molecule and the first matrix polymer are intimately mixed, exhibit macrophase separation, or exhibit microphase separation.

32-33. (canceled)

34. The article of claim 21, wherein the blend comprises about 0.001 to 10% by weight of the mechanochromic molecule.

35. (canceled)

36. The additive manufacturing method of claim 1, wherein fusing the material comprises vat polymerization.
